(19) United States
(12) Patent Application Publication
(10) Pub. No.: US 2022/0370983 A1
(43) Pub. Date: Nov. 24, 2022

(54) YOLK-SHELL NANOPARTICLES FOR THE REMOVAL OF H2S FROM GAS STREAMS

(71) Applicants: Abu Dhabi National Oil Company, Abu Dhabi (AE); Khalifa University of Science and Technology, Abu Dhabi (AE)

(72) Inventors: Yasser AL WAHEDI, Abu Dhabi (AE); Shaima Hamad AL YAFEI, Abu Dhabi (AE); Georgia BASINA, Abu Dhabi (AE); Vasileios TZITZIOS, Abu Dhabi (AE)

(21) Appl. No.: 17/763,070

(22) PCT Filed: Sep. 26, 2019
(86) PCT No.: PCT/IB2019/058169

§ 371 Date: Mar. 23, 2022

(51) Int. Cl. B01J 20/28; B01J 20/10; B01J 20/02; B01J 20/30; B01J 20/32; B01J 20/34; B01D 53/52; B01D 53/96

(52) U.S. Cl. CPC B01J 20/28021; B01J 20/103; B01J 20/0237; B01J 20/3078; B01J 20/3293; B01J 20/3483; B01D 53/52; B01D 53/96; B01D 2251/602; B01D 2257/304

(57) ABSTRACT

The present invention relates yolk-shell nanoparticles having both a high stability towards sintering and high H₂5 adsorption capacities, the use of the yolk-shell nanoparticles in a method for H₂S removal from gas streams, and a corresponding method for H₂S removal from gas streams also comprising the regeneration of the yolk-shell nanoparticles, wherein the yolk-shell nanoparticles provide for high H₂ adsorption capacities and/or high reusability.

### FIELD OF THE INVENTION

The present invention relates to the field of sulfur removal and recovery in petroleum production and industry. In particular, the present invention is directed to yolk-shell nanoparticles, the use of the yolk-shell nanoparticles in a method for H₂S removal from gas streams, and a corresponding method for H₂S removal from gas streams also comprising the regeneration of the yolk-shell nanoparticles.

### BACKGROUND OF THE INVENTION

Acid gases such as hydrogen sulfide (H₂S) and carbon dioxide (CO₂) along with other impurities often exist in crude oil and natural gas. The diminishing number of the sweet reservoirs worldwide forced many nations towards exploiting heavier and more acidic reservoirs. Since these gases pose severe hazards to both the environment and human health, more technologies to treat them are being developed to remove and recover sulfur species from the gas phase. Those processes are typically given the term H₂S removal processes (Y. Al Wahedi, A. I. Torres, S. Al Hashimi, N. I. Dowling, P. Daoutidis, and M. Tsapatsis, “Economic assessment of temperature swing adsorption systems as Claus tail gas clean up units,” Chemical Engineering Science, vol. 126, pp. 186-195, 2015; S. Ibrahim, A. Al Shoaibi, and A. Gupta, “Role of toluene in hydrogen sulfide combustion under Claus condition,” Applied energy, vol. 112, pp. 60-66, 2013).

Commonly, the recovery of sulfur species in petroleum products goes through two stages; a sweetening/desulfurization stage followed by a sulfur recovery stage. In the first stage, H₂S and other sulfur species are removed from the petroleum feed either by solvent capture for gases or by hydro-desulfurization for oil (D. M. Wang, “Breakthrough behavior of H₂S removal with an iron oxide-based CG-4 adsorbent in a fixed-bed reactor,” 2008). The captured H₂S-enriched stream is passed to the sulfur recovery unit. Nowadays, the Claus unit is the most common method used for sulfur recovery, however, it has thermodynamic limitations and leaves around 2 to 5% of the H₂S coming in untreated (R. L. Mora, “Sulphur condensation influence in Claus catalyst performance,” Journal of Hazardous Materials, vol. 79, pp. 103-115, 12/1/2000).

The dry adsorption process is an available, feasible and environmental friendly process used for H₂S removal (M. Ozekmekci, G. Salkic, and M. F. Fellah, “Use of zeolites for the removal of H₂S: A mini-review,” Fuel Processing Technology, vol. 139, pp. 49-60, 11//2015). Various types of adsorbents including metal oxides, zeolites and activated carbon have been tested.

Activated carbons have high adsorption capacities, however, they form fines due to their large micropores. Existing commercial technologies can achieve higher removal of H₂S (up to 99.9%) but come at a relatively high capital and operating cost (X. Zhang, G. Dou, Z. Wang, L. Li, Y. Wang, H. Wang, et al., “Selective catalytic oxidation of H₂S over iron oxide supported on alumina-intercalated Laponite clay catalysts,” Journal of hazardous materials, vol. 260, pp. 104-111, 2013).

Metal oxides enjoy the attributes of high density and high capacity. The use of metal oxides as adsorbents usually results into the formation of non-regenerable side products that are thermodynamically stable. Moreover, metal oxides lose their activity when subjected to repeated sulfidation and oxidation cycles due to sintering (M. Behl, J. Yeom, Q. Lineberry, P. K. Jain, and M. A. Shannon, “A regenerable oxide-based H₂S adsorbent with nanofibrous morphology,” Nature nanotechnology, vol. 7, pp. 810-815, 2012). Sintering refers to the formation of agglomerates from metal oxide crystallites during adsorption and regeneration. Consequently, sintering leads to the formation of bigger crystals of metal oxides, which possess a smaller surface area and less reactive sites. In summary, sintering leads to a loss of adsorbent capacity.

The problem of sintering has been addressed in the past by developing metal-based nanoparticles such as metal oxide/sulfide/sulfate/hydroxides nanoparticles being stabilized, i.e. protected from sintering by a support, e.g. a porous inert oxide material, or, by an encapsulation, e.g. in the form of core-shell nanoparticles, wherein the metal-based nanoparticles are encapsulated by a shell made from a porous inter oxide material. In particular, copper oxide-based adsorbents are known in the art for the removal of sulfur species from gas streams. For example, WO2015/073372 relates to a mesoporous silica support material which is impregnated with copper oxide nanoparticles. The nanoparticles are uniformly distributed throughout the porous silica support and sulfur compounds are adsorbed on the nanoparticles. Supporting metal oxides on mesoporous silica generally addresses the sintering problem. However, supporting metal oxides on mesoporous silica results in low adsorption capacities.

In the past, metal oxides or mixed metal oxides on mesoporous support such as silica-supported copper and zinc oxides were identified to be stable during H₂S adsorption-regeneration cycles (B. Elyassi, Y. Al Wahedi, N. Rajabbeigi, P. Kumar, J. S. Jeong, X. Zhang, et al., “A high-performance adsorbent for hydrogen sulfide removal,” Microporous and Mesoporous Materials, vol. 190, pp. 152-155, 2014). However, silica-supported copper and zinc oxides appeared to have low H₂S adsorption capacities ranging between 0.16 to 2.5 mmol S/g of adsorbent (B. Elyassi, Y. Al Wahedi, N. Rajabbeigi, P. Kumar, J. S. Jeong, X. Zhang, et al., “A high-performance adsorbent for hydrogen sulfide removal,” Microporous and Mesoporous Materials, vol. 190, pp. 152-155, 2014, Table 1). Consequently, metal oxides or mixed metal oxides on mesoporous supports such as silica-supported copper and zinc oxides require large bed volumes to achieve the required H₂S removal causing many practical and environmental issues.

Thus, there is need for improved adsorbents for H₂S which have a high H₂S adsorption capacity on the one hand and which are stable during regeneration, i.e. loss of H₂S adsorption capacity due to sintering is minimized, on the other. Specifically, it is desirable to provide for regenerable adsorbents being highly reactive towards H₂S, i.e. having a high loading of metal-based nanoparticles and having pores allowing for high diffusion capability, while side reactions are minimized at the same time. More important, the adsorbents should not undergo sintering at the high temperatures needed for the regeneration of the adsorbents.

However, supporting the nanoparticles by a porous inert oxide material may lead to reduced absorbance capacities, while the shell of core-shell nanoparticles might block some of the active surfaces of the catalysts.

Therefore, it is desirable to provide for nanoparticulate adsorbent materials balancing out reactivity, i.e. activity and selectivity, and stability towards sintering. Thus, it is preferred to provide for metal-based nanoparticles protected by a spherical shell made from an inert oxide material, wherein there is a void space between the shell and the metal-based nanoparticles, allowing for the metal-based nanoparticles to expand and contract during adsorption and regeneration without hindrance or agglomeration.

### SUMMARY OF THE INVENTION

The present invention relates to yolk-shell nanoparticles having both a high stability towards sintering and high H₂S adsorption capacities.

The present invention solves the shortcomings of the prior art by yolk-shell nanoparticles comprising a mesoporous inert oxide material as a shell and as the “yolk” metal-based nanoparticles, such as metal oxide, metal sulfide, metal sulfate, and/or metal hydroxide nanoparticles, wherein the metal-based nanoparticles are contained by said shell and wherein there is a void space between the shell and the metal-based nanoparticles.

In particular, the present invention relates to yolk-shell nanoparticles as adsorbents for H₂S, wherein the yolk-shell nanoparticles according to the present invention comprise a mesoporous silica shell and copper-based nanoparticles, such as copper oxide, copper sulfide, copper sulfate, and/or copper hydroxide nanoparticles, wherein the copper-based nanoparticles are contained by said shell and wherein there is a void space between the shell and the copper-based nanoparticles.

In another aspect, the invention relates to a process for producing the yolk-shell nanoparticles according to the present invention comprising the steps of:
(i) Providing a copper-based precursor having a low density;
(ii) forming a mesoporous silica shell around the provided copper-based precursor;
(iii) thermally treating the mesoporous silica shell comprising the provided copper-based precursor, wherein the copper-based precursor shrinks to form the copper oxide nanoparticles and a void space between the mesoporous silica shell and the copper oxide nanoparticles.

In a further aspect, the invention relates to a process for H₂S removal from gas streams comprising the steps of:
(i) Adsorbing H₂S from a gas stream comprising H₂S using the yolk-shell nanoparticles according to the present invention, wherein the yolk-shell nanoparticles are exposed to the H₂S-comprising gas stream until the H₂S-absorbance capacity of the yolk-shell nanoparticles is reached;
(ii) regenerating the yolk-shell nanoparticles, wherein the yolk-shell nanoparticles are heated at a temperature of at least 600° C. in an 150° C. and 100 ppm H₂S stream until the respective metal oxide nanoparticles residing in the hollow spheres of the yolk-shell nanoparticles are regenerated, which efficiently adsorbs H₂S from gas streams again.

For a detailed understanding of the present invention, reference should be made to the following detailed description in conjunction with the drawings and embodiments according to the present invention.

### BRIEF DESCRIPTION OF THE FIGURES

In the following, preferred embodiments of the invention are described with reference to the figures, in which:

FIG. 1 shows X-Ray powder diffraction patterns of copper oxide nanoparticles as copper-based precursors for the synthesis of the yolk-shell nanoparticles according to an embodiment of the present invention, specifically (a) metallic copper, Cu (b) covellite, CuS, (c) cuprite, Cu₂O and (d) tenorite, CuO and (e) sphertiniite Cu(OH)₂.

FIG. 2 shows microscopic images of copper oxide nanoparticles as copper-based precursors for the synthesis of the yolk-shell nanoparticles according to an embodiment of the present invention.

FIG. 3 shows microscopic images of the yolk-shell nanoparticles according to an embodiment of the present invention before calcination.

FIG. 4 shows diffraction patterns of yolk-shell nanoparticles according to an embodiment of the present invention before and after calcination.

FIG. 5a, b show microscopic images of yolk-shell nanoparticles according to an embodiment of the present invention.

FIG. 6 shows diffraction patterns of yolk-shell nanoparticles according to an embodiment of the present invention, wherein the silica shell around the copper-based nanoparticles was formed in (a) water and (b) in ethanol.

FIG. 7a shows a microscopic image of yolk-shell nanoparticles according to an embodiment of the present.

FIG. 7b shows diffraction patterns of yolk-shell nanoparticles according to an embodiment of the present invention comprising copper sulfide nanoparticles (bottom) before forming the silica shell, (middle) before and (top) after calcination.

FIG. 8a, b show microscopic images of copper oxide nanoparticles without a silica shell (a) before and (b) after calcination.

FIG. 9 shows diffraction patterns of copper oxide nanoparticles without a silica shell (top) before and (bottom) after calcination.

FIG. 10a, b show H₂S breakthrough curves from reactors comprising yolk-shell nanoparticles according to a further embodiment of the present invention.

FIG. 11 shows representative TEM images of yolk-shell nanoparticles according to a further embodiment of the present invention comprising different relative amount by weight of mesoporous silica shell.

FIG. 12 shows H₂S breakthrough curves from reactors comprising yolk-shell nanoparticles according to a further embodiment of the present invention.

FIG. 13a shows powder XRD patterns of various copper-based precursors according to another embodiment of the present invention, wherein CuO and Cu(OH)₂ structures were prepared from CuSO₄ at varying pH in alkaline aqueous medium.

FIG. 13b shows powder XRD patterns of a copper-based precursor according to another embodiment of the present invention, wherein Cu(OH)₂ nanoparticles were prepared at pH=10 after 1 hour and exposure to air for 1 and 2 days.

FIG. 14 shows X-Ray powder diffraction patterns of Cu(OH)₂ particles as copper-based precursors according to another embodiment of the present invention, wherein the Cu(OH)₂ particles were prepared from copper sulfate as copper-based starting material and sodium hydroxide as a base, without (a) and in the presence of 400 mg CTAB (b) and 200 mg PVP-10 (c) in slightly alkaline environment of pH=8.

FIG. 15 shows TEM Images of Cu(OH)₂ particles as copper-based precursors according to another embodiment of the present invention, wherein the Cu(OH)₂ particles were prepared in water from copper sulfate as copper-based starting material and sodium hydroxides as a base in the presence of CTAB (SAD-13A, on the top) and after calcination Cu(OH)₂/CTAB/SiO₂ at 450° C. for 2 hours (at the bottom).

FIG. 16a+b shows X-Ray powder diffraction patterns of Cu(OH)₂ particles as copper-based precursors according to another embodiment of the present invention, wherein the Cu(OH)₂ particles were prepared from copper sulfate as copper-based starting material and sodium hydroxide as a base in water at pH=8 in the presence of 200 mg PVP-10, before (a) and after the addition of silica source of TEOS in neutral (A) and alkaline medium(B) as received (b) and after calcination at 450° C. for 2 hours (c).

FIG. 17 shows SEM images of CuO/SiO2 (SAD-6B) particles according to a further embodiment of the present invention prepared in water from copper sulfate and sodium hydroxides in alkaline conditions (pH=10), without any surfactant.

FIG. 18 shows powder XRD patterns of a copper-based precursor according to another embodiment of the present invention (as-made Cu(OH)₂ nanoparticles) and the resulting yolk-shell nanoparticles after thermal treatment (calcination) at 450° C. for 2 hours.

FIG. 19 shows SEM (top) and TEM (bottom) images of yolk-shell nanoparticles according to a further embodiment of the present invention, wherein the yolk-shell nanoparticles were prepared in various solvents and thermally treated at 450° C. for 2 hours.

FIG. 20 shows H₂S adsorption curves at 150° C. of yolk-shell nanoparticles according to a further embodiment of the present invention, wherein the yolk-shell nanoparticles comprise various relative amounts by weight (% w.t.) of copper oxide nanoparticles, and wherein the copper oxide nanoparticles have a mean crystallite size of 4.3 nm in all cases. The relative amounts of copper oxide nanoparticles were varied by using different solvents or mixtures of solvents for the formation of the silica shell, i.e. (a) water, (b) water/ethanol (b) and (c) ethanol.

FIG. 21 shows H₂S adsorption curves at 150° C. and 100 ppm H₂S, of yolk-shell nanoparticles according to a further embodiment of the present invention, wherein the yolk-shell nanoparticles comprise copper oxide nanoparticles having a mean crystallite sizes of (a) 13 nm (b) 6.6 nm and (c) 4.3 nm.

FIG. 22a+b show TEM Images of CuO/SiO₂ SAD-3B (on the top of FIG. 22a) and SAD-₄B (at the bottom of FIG. 22a) and SEM Images of CuO/SiO2 of SAD-3B (a) and SAD-5B (b) according to another embodiment of the present invention (FIG. 22b).

FIG. 23a shows H₂S adsorption curves at 150° C. for CuO/SiO₂ yolk-shell nanoparticles according to another embodiment of the present invention having a CuO crystallite size of 10.4 nm and a relative amount by weight of copper oxide relative to the weight of the yolk-shell nanoparticles of 98.8 w.t. %: for the 1^{st} fresh cycle (a) and after regeneration at 600° C/7 h, 2^{nd} cycle of H₂S adsorption (b). The corresponding H₂S capacities are 11.5 mmol/g and 1.32 mmol/g, respectively (SG-16B), corresponding to an 88.5% drop of sulfur capacity.

FIG. 23b shows SEM (on the top) and TEM (at the bottom) images of CuO/SiO₂ CuO/SiO₂ yolk-shell nanoparticles according to another embodiment of the present invention having a CuO crystallite size of 10.4 nm and a relative amount by weight of copper oxide relative to the weight of the yolk-shell nanoparticles of 98.8 w.t.% (SG-16B prepared in ethanol using 4 nm Cu(OH)2 as copper-based precursor provided in water in the presence of CTAB.

FIG. 24a+b show X-Rays diffraction patterns of Cu(OH)₂/SiO₂ yolk-shell nanoparticles according to another embodiment of the present invention as received from ethanol before (A) and after calcination (B) at 450° C. for 2 hours: (a) SAD-36_1A, (b) SG-16A, (c) SAD-36_2A, (d) SAD-36_4A and (e) SAD-36_3A.

FIG. 25a-c show multicycle H₂S adsorption curves of CuO nanoparticles according to another embodiment of the present invention resulting from thermal treatment at 450° C. of Cu(OH)₂ nanoparticles, prepared in water from copper sulfate as copper-based starting material with sodium hydroxide as a base at pH=10, where (A) CuO nanoparticles, (B) CuO/SiO₂ nanostructures obtained without the presence of any surfactant and (c) CuO/SiO₂yolk-shell nanoparticles prepared in the presence of CTAB as a surfactant. The regeneration was carried out at 600° C. for 7 hours, where (a) represent H₂S curves for the fresh adsorbents and (b-e) represent H₂S curves for the regenerated sorbents at 700° C. from the 2^{nd} cycle up to the 5^{th} cycle respectively.

FIG. 26a-c show multicycle H₂S adsorption curves of CuO/SiO₂ yolk-shell nanoparticles according to another embodiment of the present invention resulting from hydrolysis/condensation of TEOS in ethanol, after thermal treatment at 450° C., where (a) represent H₂S curves for the fresh adsorbents and (b-e) represent H₂S curves for the regenerated sorbents at 700° C. from the 2^{nd} cycle up to the 4^{th} cycle respectively. The regeneration of the studied adsorbents was carried out at 600° C. for 7 hours.

FIG. 27 shows schematic representations of different embodiments according to the present invention: at the upper left is shown a core-shell nanoparticle (1) comprising copper-based nanoparticles (3) encapsulated in a silica shell (2); at the upper right is shown a yolk-shell nanoparticle according to the present invention (4) comprising copper-based nanoparticles (6) being contained by the mesoporous silica shell (2) and wherein there is a void space between the mesoporous silica shell (2) and the one or more copper-based nanoparticles (6); at the lower right is shown the product obtained after forming the silica shell around the copper-based precursor in the presence of a surfactant according to the process for producing the yolk-shell nanoparticles according to the invention, step (ii), i.e. a silica shell (2), the copper-based precursor (3) provided in step (i) encapsulated by micelles (8) formed by the surfactant providing a structural scaffold.

FIG. 28a-d show hysteresis N₂ adsorption-desorption curves at 77 K with corresponding pore-size distributions for yolk-shell nanoparticles according to another embodiment of the present invention having relative amounts by weight of CuO: (A) 67.2 w.t.-% CuO,

FIG. 28a and FIG. 28b, (Sample SAD-36-4B) and (B) 43.0 w.t.-% CuO, FIG. 28c and FIG. 28d (Sample SAD-36-3B).

### DETAILED DESCRIPTION OF THE INVENTION

“Nanoparticle” according to the present invention refers to inorganic particulate matter having an average particle size in the nanometers range.

“Yolk-shell nanoparticles” according to the present invention refers to nanoparticulate material comprising metal oxide nanoparticles contained by hollow shells made from a mesoporous inert oxide material. In other words, in yolk-shell nanoparticles there is a void space separating the metal oxide nanoparticles from the mesoporous shell. As it is known in the art, yolk-shell nanoparticles generally have low densities and large surface areas. Moreover, yolk-shell nanoparticles commonly also provide for a high molecular loading capacity in the void space, and also for a tunable void space. Due to these properties, yolk-shell nanoparticles may outperform classical core-shell or hollow nanoparticles. In the art, yolk-shell nanoparticles are known in various fields, such as catalysis, sensors, lithium batteries, biomedical applications, or adsorbents.

Porous materials can be characterized, e.g. by nitrogen adsorption/desorption isotherms at 77 K, e.g. the Brunauer-Emmett-Teller, BET, isotherms or and Barret-Joyner-Halenda, BJH, isotherms. As is known in the art, such analysis allows for determination of surface area (BET isotherms), pore volume and pore size distribution (BJH isotherm) and thus also the “average pore size”. “Average pore size” as used throughout this application refers to the average pore size as determined by nitrogen adsorption/desorption isotherms, specifically the BJH isotherm.

“H₂S adsorption capacity” according to the present invention refers to the maximum amount of H₂S adsorbed by the yolk-shell nanoparticles. The H₂S adsorption capacity may for example be determined from H₂S adsorption curves as described in the examples according to this invention. The H₂S adsorption capacity may be expressed in the amount of H₂S adsorbed per amount of yolk-shell nanoparticles, e.g. in mmol/g, or in the amount of H₂S adsorbed per amount of copper oxide nanoparticles, e.g. in mmol/g_{CuO}.

“Stabilized H₂S adsorption capacity” according to the present invention refers to an H₂S adsorption capacity which does not change more than 10% from one absorption/regeneration cycle to the other, i.e. the H₂S adsorption capacity is within the experimental error margin of 10%.

“Reusability” according to the present invention relates to the ability of the same material to be used in multiple repeated cycles of adsorption and regeneration without substantially compromising the H₂S-absorbance capacity.

### The Yolk-shell Nanoparticles

The present invention relates to yolk-shell nanoparticles comprising a mesoporous silica shell and copper-based nanoparticles, such as copper oxide, copper sulfide, copper sulfate, and/or copper hydroxide nanoparticles, wherein the copper-based nanoparticles are contained by said shell and wherein there is a void space between the shell and the copper-based nanoparticles. The void space between the shell and the copper-based nanoparticles allows the particles to expand and contract freely during adsorption and desorption reactions, which in turn leads to a high reactivity of the copper-based nanoparticles.

The copper-based nanoparticles contained by said mesoporous silica shell are actively involved in the adsorption and desorption reactions with the reactants from the gas streams, such as H₂S.For example, the adsorption of H₂S is a direct chemical reaction between the copper oxide and the H₂S, wherein the copper oxide is consumed by the reaction. In particular, copper oxide nanoparticles are highly reactive towards H₂S and form copper sulfate. Consequently, the yolk-shell nanoparticles according to the present invention exhibit high H₂S adsorption capacities.

The mesoporous silica shell allows reactants to permeate to the inside of the yolk-shell nanoparticles and to contact the copper-based nanoparticles contained by said shell, wherein the chemical reaction between the copper-based nanoparticles and the reactants is largely unaffected by the shell. Further, during regeneration of the yolk-shell nanoparticles, the copper-based nanoparticles contained by the mesoporous silica shell are unable to make contact and agglomerate because of the physical barrier created by the silica shell. The copper-based nanoparticles may thus be regenerated while sintering is kept to a minimum. This allows for reusing the yolk-shell nanoparticles in multiple cycles of adsorption, i.e. H₂S-removal from gas streams, and regeneration, i.e. stripping the adsorbed species off the copper-based nanoparticles, without decreasing the adsorption capacity of the yolk-shell nanoparticles. The yolk-shell nanoparticles according to the present invention show higher reusability than other materials known in the art.

### Synthesis of the Yolk-shell Nanoparticles

In another aspect, the invention relates to a process for producing the yolk-shell nanoparticles according to the present invention comprising the steps of:
(i) Providing a copper-based precursor having a low density;
(ii) forming a silica shell around the provided copper-based precursor;
(iii) thermally treating the silica shell comprising the provided copper-based precursor.

As a first step, a copper-based precursor having a low density, such as copper oxide, copper sulfide, copper sulfate, and/or copper hydroxide is provided. A suitable copper-based starting material for the synthesis of the copper-based precursor according to the present invention is selected from the group consisting of copper oxides, copper sulfides, copper sulfates, copper hydroxides, copper acetate, copper acetylacetonate, copper halides and/or any combination thereof. Suitable copper-based starting materials for the synthesis of the copper-based precursor according to the present invention comprise copper salts, such as, for example—but not limited to—, copper actetate, copper sulfate, copper acetylacetonate and/or any combination thereof. The synthesis of the copper-based precursor may be performed either in water or in organic solvents. Suitable organic solvents according to the present invention comprise aliphatic amines selected from the group consisting of trioctyl amine, octyl amine, octadecyl amine, hexadecyl amine, dodecyl amine, oleyl amine and/or any combination thereof. Also, the synthesis of the copper-based precursor may be performed in the presence of a surfactant. Suitable surfactants according to the present invention employed during the provision of the copper-based precursor comprise one or more surfactants selected from the group consisting of cetyltrimethylammonium bromide (CTAB), cetyltrimethylammonium chloride (CTAC), polyvinyl pyrrolidone (PVP), tetradecylsulfonate, tetradecylphosphonic acid (TDPA) and/or any combination thereof. Further, the synthesis of the copper-based precursor may be performed either under air and/or under an atmosphere of an inert gas such as, for example—but not limited to—nitrogen or argon. Reaction temperatures for the synthesis of the copper-based precursor are in the range of 15 to 300° C., e.g. at room temperature, 20 to 30° C., or at elevated temperatures such as 100 to 280° C., 150 to 250° C., 200-280° C. or 100 to 250° C. Also, the synthesis of the copper-based precursor may be performed under neutral to alkaline conditions, i.e. a pH value ranging from 7 to 14, preferably from 8 to 12, more preferably from 9 to 11, and most preferably the pH is 10. Suitable bases comprise, for example—but are not limited to—sodium hydroxide, potassium hydroxide, ammonium hydroxide, and/or any combination thereof.

Second, the mesoporous silica shell is formed around the provided copper-based precursor. Formation of the mesoporous silica shell may be realized via current methods known in the art, such as sol-gel processes. In particular, the mesoporous silica shell is formed via the well-known Stober process which is a hydrolysis-condensation reaction starting from suitable molecular silica precursors such as tetraethyl orthosilicate (TEOS) or tetramethyl orthosilicate (TMOS) and/or any combination thereof. Silica obtained via the Stober process have the advantage that they exhibit monodisperse (uniform) particle sizes. Preferably, the silica is formed in the presence of a surfactant which is removed from the silica reaction product by calcination. Suitable surfactants according to the present invention employed during the formation of the mesoporous silica shell comprise one or more surfactants selected from the group consisting of cetyltrimethylammonium bromide (CTAB), cetyltrimethylammonium chloride (CTAC), polyvinyl pyrrolidone and/or any combination thereof. This allows for the formation of monodisperse silica particles having pores. In dependence on the reaction conditions, such as the solvent, the surfactant, reactant concentrations, catalysts, temperature and/or the pH value, the diameter and volume of the pores may be varied. This allows for control of physical properties such as the surface area.

In a third step, the reaction product obtained by the formation of the silica shell around the copper-based precursor is thermally treated. Thereby, the surfactant is removed from the silica shell and mesopores are formed in the silica shell. In addition, the copper oxide nanoparticles are formed from the copper-based precursor. In particular, thermal treatment is realized by heating the reaction product obtained by the formation of the silica shell around the copper-based precursor to temperatures higher than the decomposition temperature of the surfactant. Thermal treatment of the reaction product obtained by the formation of the silica shell around the copper-based precursor is, for example—but not limited to, performed at temperatures of 400° C. or above, such as 450° C. Moreover, upon thermal treatment the copper-based precursors shrink due to transformation into a denser phase of copper oxide, which leads to a void space between the finally obtained copper oxide nanoparticles and the finally obtained mesoporous silica shell.

Thus, the final product of the synthesis described here are yolk-shell nanoparticles, wherein the copper oxide nanoparticles reside in a hollow sphere inside the mesoporous silica structure wherein a void space between the mesoporous silica shell and the copper oxide nanoparticles is formed. This allows for the copper-oxide nanoparticles to expand and contract within the mesoporous silica shell during adsorption and regeneration, while sintering is prevented concurrently.

### H₂S Removal Process

In a further aspect, the invention relates to a process for H₂S removal from a gas stream comprising the steps of:
(i) Adsorbing H₂S from a gas stream comprising H₂S using the yolk-shell nanoparticles according to the present invention, wherein the yolk-shell nanoparticles are exposed to the H₂S-comprising gas stream until the H₂S-absorbance capacity of the yolk-shell nanoparticles is reached; and, optionally
(ii) regenerating the yolk-shell nanoparticles, wherein the yolk-shell nanoparticles are heated in an oxidant stream until the respective copper-based nanoparticles residing in the hollow spheres of the yolk-shell nanoparticles are regenerated, which efficiently adsorbs H₂S from gas streams again.

The process according to the present invention relates to removal of H₂S from a gas stream. According to the present invention, H₂S is efficiently removed from a gas stream by adsorption to the yolk-shell nanoparticles according to the present invention.

In particular, adsorbing H₂S from a gas stream comprises a direct chemical reaction between H₂S from the gas stream and the copper oxide nanoparticles residing in the silica spheres of the yolk-shell nanoparticles, wherein the copper oxide is consumed by the reaction. Copper oxide nanoparticles are highly reactive towards H₂S and form copper sulfate. Consequently, the yolk-shell nanoparticles according to the present invention exhibit high H₂S adsorption capacities.

Further, regenerating the yolk-shell nanoparticles comprises converting the reaction product of the adsorption process comprising copper-based nanoparticles such as copper sulfate nanoparticles into copper oxide nanoparticles which are again reactive for H₂S removal, i.e. the adsorption reaction with H₂S. Regeneration of the yolk-shell nanoparticles may comprise stripping the adsorbed species off the copper-based nanoparticles, e.g. via a chemical reaction. Stripping the adsorbed species off the copper-based nanoparticles may involve a chemical reaction with an oxidant, comprised in an oxidant stream. A suitable oxidant stream according to the present invention may comprise an oxidant gas or gas mixture, preferably wherein the oxidant gas or gas mixture comprises oxygen, most preferably wherein the oxidant stream is air. Regenerating the yolk-shell nanoparticles comprises heating the yolk-shell nanoparticles in an oxidant stream to a temperature of at least 500° C., preferably of at least 550° C., more preferably of at least 650° C., even more preferably of at least 700° C. and most preferably of at least 600° C. for 1 hour, preferably for more than 1 hour, more preferably for more than 6 hours, and most preferably for 7 hours. Specifically, the present invention relates to a process for H₂S removal from a gas stream comprising both steps (i) and (ii), wherein in step (ii) the yolk-shell nanoparticles are heated in an oxidant stream to a temperature of 600° C. for 7 hours, wherein the oxidant stream is a stream of air.

The void space between the copper-based nanoparticles and the mesoporous silica shells is of great importance for both adsorbing and regenerating the yolk-shell nanoparticles since it allows the copper-based nanoparticles to expand and contract during adsorption and regeneration without hindrance, while sintering is prevented at the same time. This allows for reusing the yolk-shell nanoparticles in multiple cycles of adsorption, i.e. H₂S-removal from gas streams, and regeneration, i.e. stripping the adsorbed species off the copper-based nanoparticles, without effectively decreasing the adsorption capacity of the yolk-shell nanoparticles. Thus, the yolk-shell nanoparticles according to the present invention show higher reusability than other materials known in the art.

### Preferred Embodiments of the Invention

In the following, embodiments and variations according to the present invention are described in more detail. It is, however, emphasized that the present invention is not limited to these embodiments and variations. It is also mentioned that in the following only individual embodiments of the invention can be described in more detail. The skilled person will realize, however, that the individual features described in relation to these specific embodiments of the adsorbent composition are all as such within the scope of the invention, and that individual features may also be omitted if these seem dispensable in a given case.

The present invention relates to yolk-shell nanoparticles comprising a mesoporous silica shell and copper-based nanoparticles, such as copper oxide, copper sulfide, copper sulfate, and/or copper hydroxide nanoparticles, wherein the copper-based nanoparticles are contained by said shell and wherein there is a void space between the shell and the copper-based nanoparticles. This allows for the copper-oxide nanoparticles to expand and contract within the mesoporous silica shell during adsorption and regeneration, while sintering is prevented concurrently.

In an embodiment according to the invention the yolk-shell nanoparticles comprise copper oxide nanoparticles. In another embodiment according to the invention the yolk-shell nanoparticles comprise copper sulfide nanoparticles. In another embodiment according to the invention the yolk-shell nanoparticles comprise copper sulfate nanoparticles. In another embodiment according to the invention the yolk-shell nanoparticles comprise copper hydroxide nanoparticles. In a preferred embodiment according to the present invention, the yolk-shell nanoparticles comprise copper oxide nanoparticles. Copper oxide nanoparticles are highly reactive towards H₂S and form copper sulfate. Consequently, the yolk-shell nanoparticles according to the present invention comprising copper oxide nanoparticles exhibit high H₂S adsorption capacities.

In an embodiment according to the present invention, the yolk-shell nanoparticles comprise copper-based nanoparticles having monodisperse particle sizes. In another embodiment according to the invention, the yolk-shell nanoparticles comprise copper-based nanoparticles having a monodisperse particle size from 1 to 50 nm, preferably from 1 to 30 nm, more preferably from 1 to 20 nm, even more preferably from 1 to 15 nm, and/or most preferably from 1 to 8 nm. In a preferred embodiment according to the present invention, the yolk-shell nanoparticles comprise copper-based nanoparticles having a monodisperse particle size from 1 to 15 nm. In an even more preferred embodiment according to the present invention, the yolk-shell nanoparticles comprise copper-based nanoparticles having a monodisperse particle size from 1 to7 nm. This provides for a high surface area and thus a high reactivity in the adsorbing as well as in the regeneration reaction, respectively.

In a further embodiment according to the present invention, the yolk-shell nanoparticles have mesoporous silica wherein the average pore size of the pores within the mesoporous silica shell is in the range from 10 to 40 nm, preferably from 15 to 30 nm, and more preferably from 20 to 25 nm. This provides for diffusion of molecules from the exterior through the silica shell to the CuO crystallites in the inside of the yolk-shell nanoparticles, while movement of CuO crystallites between individual yolk-shell nanoparticles and potential subsequent sintering is prevented.

In another embodiment according to the present invention, the yolk-shell nanoparticles comprise a relative amount by weight of copper-based nanoparticles relative to the total weight of the yolk-shell nanoparticles of 25 to 99 w.t.-%, preferably 40 to 99 w.t.-%, more preferably 50 to 99 w.t.-%, even more preferably 60 to 99 w.t.-% and most preferably between 65 to 99 w.t.-%. In a preferred embodiment according to the present invention the yolk-shell nanoparticles comprise a relative amount by weight of copper-based nanoparticles relative to the total weight of the yolk-shell nanoparticles of 65 to 99 w.t.-%. This provides for yolk-shell nanoparticles allowing for balancing out reactivity, i.e. activity and selectivity, and stability towards sintering. In other words, this provides for both high H₂S adsorption capacities during H₂S adsorption from gas streams on the one hand and high stability towards sintering during regeneration at the other at the same time.

In another embodiment according to the present invention, the yolk-shell nanoparticles according to the present invention provide for high H₂S adsorption capacities at temperatures ranging from 25 to 150° C. and H₂S concentrations of 1 to 1400 ppm. In a preferred embodiment according to the present invention, the yolk-shell nanoparticles according to the present invention provide for a high H₂S adsorption capacitiy at a temperature of 150° C. and an H₂S concentration of 100 ppm.

In a further embodiment according to the present invention, the yolk-shell nanoparticles provide for a H₂S adsorption capacity per amount of yolk-shell nanoparticles at temperatures ranging from 25 to 150° C. and H₂S concentrations of 1 to 1400 ppm , preferably at a temperature of 150° C. and an H₂S concentration of 100 ppm, of at least 2 mmol/g, preferably of at least 4 mmol/g, more preferably of at least 6 mmol/g, even more preferably of at least 8 mmol/g, and most preferably of at least 10 mmol/g.

In yet another embodiment according to the present invention, the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of at least 2 mmol/g_{CuO}, preferably of at least 4 mmol/g_{CuO}, more preferably of at least 6 mmol/g_{CuO}, even more preferably of at least 8 mmol/g_{CuO}, and most preferably of at least 10 mmol/g_{CuO}.

In an embodiment according to the present invention, the yolk-shell nanoparticles comprise copper oxide nanoparticles having a monodisperse particle size from 1 to 50 nm, preferably from 1 to 30 nm, more preferably from 1 to 20 nm, even more preferably from 1 to 15 nm, most preferably from 1 to 8 nm, and wherein the yolk-shell nanoparticles comprise a relative amount by weight of copper-based nanoparticles relative to the total weight of the yolk-shell nanoparticles of 25 to 99 w.t.-%, preferably 40 to 99 w.t.-%, more preferably 50 to 99 w.t.-%, even more preferably 60 to 99 w.t.-% and most preferably 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of at least 2 mmol/g_{CuO}, preferably of at least 4 mmol/g_{CuO}, more preferably of at least 6 mmol/g_{CuO}, even more preferably of at least 8 mmol/g_{CuO}, and most preferably of at least 10 mmol/g_{CuO}, or any combination thereof. In a preferred embodiment according to the present invention, the yolk-shell nanoparticles comprise copper oxide nanoparticles having a monodisperse particle size from 1 to 20 nm, wherein the yolk-shell nanoparticles comprise a relative amount by weight of copper-based nanoparticles relative to the total weight of the yolk-shell nanoparticles of 60 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 2 mmol/g_{CuO}. In a more preferred embodiment according to the present invention, the yolk-shell nanoparticles comprise copper oxide nanoparticles having a monodisperse particle size from 1 to 15 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 4 mmol/g_{CuO}. In another preferred embodiment according to the present invention, the yolk-shell nanoparticles comprise copper oxide nanoparticles having a monodisperse particle size from 1 to 15 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 10 mmol/g_{CuO}.

Another embodiment according to the present invention relates to a process for producing the yolk-shell nanoparticles according to the present invention comprising the steps of:
(i) Providing a copper-based precursor having a low density;
(ii) forming a silica shell around the provided copper-based precursor;
(iii) thermally treating the silica shell comprising the provided copper-based precursor, wherein a mesoporous silica shell is formed, and wherein the copper oxide nanoparticles are formed from the copper-based precursor, and wherein a void space between the mesoporous silica shell and the copper oxide nanoparticles is formed.

In an embodiment according to the present invention, the copper-based precursor provided is selected from the group of copper oxides, copper sulfides, copper sulfates, copper hydroxides and any combination thereof. In a preferred embodiment according to the present invention, the copper-based precursor provided is copper oxide. In another preferred embodiment according to the present invention, the copper-based precursor provided is copper sulfide. In an even more preferred embodiment according to the present invention, the copper-based precursor provided is copper hydroxide.

In a further embodiment according to the present invention, providing the copper-based precursor comprises a chemical reaction involving a copper-based starting material selected from the group consisting of copper oxides, copper sulfides, copper sulfates, copper hydroxides, copper acetate, copper acetylacetonate, copper halides and/or any combination thereof. In another embodiment according to the present invention, providing the copper-based precursor comprises a chemical reaction, wherein the chemical reaction is performed in a solvent selected from the group consisting of water, organic solvent such as aliphatic amines selected from the group consisting of trioctyl amine, octyl amine, octadecyl amine, hexadecyl amine, dodecyl amine, oleyl amine and/or any combination thereof. Also, in a further embodiment according to the present invention, providing the copper-based precursor comprises a chemical reaction, wherein the chemical reaction is performed in the presence of a surfactant selected from the group consisting of cetyltrimethylammonium bromide (CTAB), cetyltrimethylammonium chloride (CTAC), polyvinyl pyrrolidone, tetradecyl sulfonate, tetradecylphosphonic acid (TDPA) and/or any combination thereof. In another embodiment according to the present invention, providing the copper-based precursor comprises a chemical reaction, wherein the chemical reaction is performed either under air and/or under an atmosphere of an inert gas selected from the group consisting of nitrogen, helium, neon, argon, krypton, xenon, sulfur hexafluoride, carbon dioxide, and/or any combination thereof. In a further embodiment according to the present invention, providing the copper-based precursor comprises a chemical reaction, wherein the reaction temperature is in the range of 15 to 300° C., preferably at room temperature or in the range of 20 to 30° C., more preferably 100 to 280° C., even more preferably 150 to 250° C., even more preferably 200-280° C. and 100 to 250° C. In another embodiment according to the present invention, providing the copper-based precursor comprises a chemical reaction, wherein the pH is in the range from 7 to 14, preferably wherein the pH is in the range from 8 to 12, more preferably wherein the pH is in the range from 9 to 11, and most preferably wherein the pH is 10. In a further embodiment according to the present invention, providing the copper-based precursor comprises a chemical reaction, wherein the base is selected from the group consisting of neutral bases, anionic bases, cationic bases, monoacidic bases, diacidic bases, triacidic bases and/or any combination thereof, preferably the base is selected from the group consisting of sodium hydroxide, potassium hydroxide, ammonium hydroxide, and/or any combination thereof. In a further embodiment according to the present invention, providing the copper-based precursor comprises a chemical reaction, wherein a second starting-material is provided, preferably wherein the second-starting material is sulfur. The variation of reaction parameters such as starting materials, solvents, surfactant, atmosphere, temperature, pH-value, and choice of a specific base allow for variation of characteristics of the resulting copper-based precursors such as elemental composition, morphology, particle size, and/or any combination thereof.

In a preferred embodiment according to the present invention, providing the copper-based precursor comprises a chemical reaction, wherein copper sulfate is the copper-based starting material, and wherein the solvent is water, and wherein the base is sodium hydroxide, and wherein the reaction temperature is room temperature, and wherein the reaction medium is alkaline, i.e. the pH is higher than 7. Such reaction conditions allow for the formation of copper-based precursors in the form of crystalline copper oxide nanoparticles, copper hydroxide nanoparticles and/or any combination thereof which allow for efficient H₂S adsorption. A pH value below 7 leads to amorphous particles which do not allow for efficient H₂S adsorption.

In a more preferred embodiment according to the present invention, providing the copper-based precursor comprises a chemical reaction, wherein copper sulfate is the copper-based starting material, and wherein the solvent is water, and wherein the base is sodium hydroxide, and wherein the reaction temperature is room temperature, and wherein the pH is in the range of 8 to 12. This allows for the provision of copper-based precursors in the form of copper hydroxide (Cu(OH)₂) nanoparticles having particle sizes in the range of 3 to 11 nm. Such a synthesis allows for the formation of copper hydroxide (Cu(OH)₂) nanoparticles having particle sizes allowing for efficient H₂S adsorption due to a large surface area.

In another more preferred embodiment according to the present invention, providing the copper-based precursor comprises a chemical reaction, wherein copper sulfate is the copper-based starting material, and wherein the solvent is water, and wherein the base is sodium hydroxide, and wherein the reaction temperature is room temperature, and wherein the pH is 10. This allows for the provision of copper-based precursors in the form of copper hydroxide (Cu(OH)₂) nanoparticles having particle sizes in the range of 5 to 8 nm not only allowing for efficient H₂S adsorption but also providing for copper hydroxide (Cu(OH)₂) nanoparticles being air-stable.

In another more preferred embodiment according to the present invention, providing the copper-based precursor comprises a chemical reaction, wherein copper sulfate is the copper-based starting material, and wherein the solvent is water, and wherein the base is sodium hydroxide, and wherein the reaction temperature is room temperature, and wherein the pH is in the range of 8 to 12, and wherein a surfactant such as cetyltrimethylammonium bromide (CTAB) or polyvinyl pyrrolidone having an average molecular weight of 10.000 g/mol (PVP-10) is present. This allows for the provision of copper-based precursors in the form of copper hydroxide (Cu(OH)₂) nanoparticles allowing for the synthesis of yolk-shell nanoparticles having both a high H₂S adsorption capacity and a high reusability.

In another preferred embodiment according to the present invention, providing the copper-based precursor comprises a chemical reaction, wherein the copper-based starting material is copper acetylacetonate, and wherein the solvent is oleyl amine. In a more preferred embodiment according to the present invention, providing the copper-based precursor comprises a chemical reaction, wherein the copper-based starting material is copper acetylacetonate, and wherein the solvent is oleyl amine, and wherein the reaction is performed under air at a reaction temperature in the range of 150° C. to 250° C. This allows for providing cuprite (Cu₂O) nanoparticles.

In another more preferred embodiment according to the present invention, providing the copper-based precursor comprises a chemical reaction, wherein the copper-based starting material is copper acetylacetonate, and wherein the solvent is oleyl amine, and wherein in the reaction is performed under an atmosphere of argon at a reaction temperature in the range of 200° C. to 280° C. This allows for providing copper (Cu(O)) nanoparticles.

In another more preferred embodiment according to the present invention, providing the copper-based precursor comprises a chemical reaction, wherein the copper-based starting material is copper acetylacetonate, and wherein the solvent is oleyl amine, and wherein the reaction is performed under an atmosphere of argon at a reaction temperature in the range of 100° C. to 250° C., and wherein elemental sulfur is added as a second starting material. This allows for providing copper sulfide (CuSₓ) nanoparticles.

In another more preferred embodiment according to the present invention, providing the copper-based precursor comprises a chemical reaction, wherein copper acetate is the copper-based starting material, and wherein the solvent is trioctyl amine, and wherein tetradecyl sulfonate is used as a surfactant. This allows for providing copper oxide (CuO) nanoparticles having a particle size of 4 nm.

In an embodiment according to the present invention, forming a silica shell around the provided copper-based precursor is performed in water, ethanol, and/or any combination thereof. In a preferred embodiment according to the present invention, forming a silica shell around the provided copper-based precursor is performed in ethanol. This allows for the formation of a uniformly shaped reaction product having a narrow size distribution.

In a further embodiment according to the present invention, forming a silica shell around the provided copper-based precursor is performed by using a molecular silica precursor selected from the group consisting of tetramethyl orthosilicate (TMOS), tetraethyl orthosilicate (TEOS) and/or any combination thereof. In a preferred embodiment, the molecular silica precursor is tetraethylorthosilicate (TEOS). In another embodiment according to the present invention, forming a silica shell around the provided copper-based precursor is performed in the presence of a surfactant selected from the group consisting of cetyltrimethylammonium bromide (CTAB), cetyltrimethylammonium chloride (CTAC) and/or combinations thereof. In a preferred embodiment, the surfactant is cetyltrimethylammonium bromide (CTAB). In a preferred embodiment according to the present invention, forming a silica shell around the provided copper-based precursor is performed in a reaction mixture comprising the provided copper-based precursor, ethanol, tetraethylorthosilicate (TEOS) and cetyltrimethylammonium bromide (CTAB). In a more preferred embodiment according to the present invention, forming a silica shell around the provided copper-based precursor is performed in a reaction mixture comprising copper hydroxide precursor, water, tetraethylorthosilicate (TEOS) and cetyltrimethylammonium bromide (CTAB). The presence of a surfactant during formation of the silica shell around the provided copper-based precursor allows for the formation of mesopores and for the formation of yolk-shell nanoparticles after thermal treatment. Such yolk-shell nanoparticles provide for a high H₂S adsorption capacity.

In a more preferred embodiment according to the present invention, forming a silica shell around the provided copper-based precursor is performed in a reaction mixture comprising the provided copper-based precursor, ethanol and tetraethylorthosilicate (TEOS), wherein no surfactant is present. After thermal treatment, this allows for the formation of yolk-shell nanoparticles providing for a high H₂S adsorption capacity.

In an even more preferred embodiment according to the present invention, forming a silica shell around the provided copper-based precursor is performed in a reaction mixture comprising the provided copper-based precursor, ethanol and tetraethylorthosilicate (TEOS), wherein no surfactant is present and wherein the concentration of TEOS is low. After thermal treatment, this allows for the formation of yolk-shell nanoparticles providing for a high H₂S adsorption capacity and a high reusability.

In a most preferred embodiment according to the present invention, forming a silica shell around the provided copper-based precursor is performed in a reaction mixture comprising the provided copper-based precursor, a mixture of ethanol and water as solvents, tetraethylorthosilicate (TEOS), and ammonium hydroxide as a base, wherein the pH is 9 and wherein no surfactant is present and wherein the concentration of TEOS is low. After thermal treatment, this allows for the formation of yolk-shell nanoparticles providing for a high H₂S adsorption capacity and a high reusability.

In another embodiment according to the present invention thermally treating the silica shell comprising the provided copper-based precursor is performed at temperatures of 400° C. or above, such as 450° C. In a further embodiment according to the present invention thermally treating the silica shell comprising the provided copper-based precursor is performed at temperatures of 400° C. or above for 0.5 hour, preferably 1 hour, more preferably for 3 or more hours and most preferably for 2 hours. In a preferred embodiment according to the present invention thermally treating the silica shell comprising the provided copper-based precursor is performed at a temperature of 450° C. In a most preferred embodiment according to the present invention thermally treating the silica shell comprising the provided copper-based precursor is performed at a temperature of 450° C. for 2 hours. By thermally treating the silica shell comprising the provided copper-based precursor a mesoporous silica shell is formed, and the copper oxide nanoparticles are formed from the copper-based precursor, and a void space between the mesoporous silica shell and the copper oxide nanoparticles is formed. This allows for providing yolk-shell nanoparticles balancing out reactivity, i.e. activity and selectivity, and stability towards sintering. In other words, this provides for both high H₂S adsorption capacities during H₂S adsorption from gas streams on the one hand and high stability towards sintering during regeneration at the other at the same time.

A further embodiment according to the present invention relates to a process for H₂S removal from a gas stream comprising the steps of:
(i) Adsorbing H₂S from a gas stream comprising H₂S using the yolk-shell nanoparticles according to the present invention, wherein the yolk-shell nanoparticles are exposed to the H₂S-comprising gas stream until the H₂S-absorbance capacity of the yolk-shell nanoparticles is reached; and, optionally
(ii) regenerating the yolk-shell nanoparticles, wherein the yolk-shell nanoparticles are heated at a temperature of at least 600° C. in an oxidant stream until the respective metal oxide nanoparticles residing in the hollow spheres of the yolk-shell nanoparticles is regenerated, which efficiently adsorbs H₂S from gas streams again.

Another embodiment according to the present invention relates to a process for H₂S removal from a gas stream comprising both steps (i) and (ii), wherein in step (ii) the yolk-shell nanoparticles are heated in an oxidant stream to a temperature of at least 500° C., preferably of at least 550° C., more preferably of at least 650° C., even more preferably of at least 700° C. and most preferably of at least 600° C.

A further embodiment according to the present invention relates to a process for H₂S removal from a gas stream comprising both steps (i) and (ii), wherein in step (ii) the yolk-shell nanoparticles are heated in an oxidant stream for 1 hour, preferably for more than 1 hour, more preferably for more than 6 hours, and most preferably for ₇ hours.

A preferred embodiment according to the present invention relates to a process for H₂S removal from a gas stream comprising both steps (i) and (ii), wherein in step (ii) the yolk-shell nanoparticles are heated in an oxidant stream to a temperature of 600° C. for ₇ hours.

A most preferred embodiment according to the present invention relates to a process for H₂S removal from a gas stream comprising the steps of:
(i) Adsorbing H₂S from a gas stream comprising H₂S using yolk-shell nanoparticles according to the present invention, wherein the yolk-shell nanoparticles are exposed to the H₂S-comprising gas stream until the H₂S-absorbance capacity of the yolk-shell nanoparticles is reached; and, optionally
(ii) regenerating the yolk-shell nanoparticles, wherein the yolk-shell nanoparticles are heated to a temperature of 600° C. in an oxidant stream for ₇ hours until the respective metal oxide nanoparticles residing in the hollow spheres of the yolk-shell nanoparticles is regenerated, which efficiently adsorbs H₂S from gas streams again.

Another embodiment according to the present invention relates to a process for H₂S removal from a gas stream comprising both steps (i) and (ii), wherein in step (ii) the oxidant stream comprises an oxidant gas or gas mixture, preferably wherein the oxidant gas or gas mixture comprises oxygen, most preferably wherein the oxidant stream is air.

An embodiment according to the present invention relates to a process for H₂S removal from a gas stream, wherein the yolk-shell nanoparticles comprise a mesoporous silica shell and copper-based nanoparticles, such as copper oxide, copper sulfide, copper sulfate, and/or copper hydroxide nanoparticles, wherein the copper-based nanoparticles are contained by said shell and wherein there is a void space between the shell and the copper-based nanoparticles.

Another embodiment according to the present invention relates to a process for H₂S removal from a gas stream, wherein the yolk-shell nanoparticles comprise copper oxide nanoparticles. In another embodiment relating to a process for H₂S removal from a gas stream according to the present invention, the yolk-shell nanoparticles comprise copper sulfide nanoparticles. In another embodiment relating to a process for H₂S removal from a gas stream according to the present invention, the yolk-shell nanoparticles comprise copper sulfate nanoparticles. In another embodiment relating to a process for H₂S removal from a gas stream according to the present invention, the yolk-shell nanoparticles comprise copper hydroxide nanoparticles. In a preferred embodiment relating to a process for H₂S removal from a gas stream according to the present invention, the yolk-shell nanoparticles comprise copper oxide nanoparticles. Copper oxide nanoparticles are highly reactive towards H₂S and form copper sulfate. Consequently, the process for H₂S removal from a gas stream according to the present invention, allows for high H₂S adsorption capacities.

A further embodiment according to the present invention relates to a process for H₂S removal from a gas stream, wherein the yolk-shell nanoparticles comprise copper-based nanoparticles having monodisperse particle sizes. Another embodiment according to the present invention relates to a process for H₂S removal from a gas stream, wherein the yolk-shell nanoparticles comprise copper-based nanoparticles having a monodisperse particle size from 1 to 50 nm, preferably from 1 to 30 nm, more preferably from 1 to 20 nm, even more preferably from 1 to 15 nm, and/or most preferably from 1 to 8 nm. A preferred embodiment according to the present invention relates to a process for H₂S removal from a gas stream, wherein the yolk-shell nanoparticles comprise copper-based nanoparticles having a monodisperse particle size from 1 to 15 nm. An even more preferred embodiment according to the present invention relates to a process for H₂S removal from a gas stream, wherein the yolk-shell nanoparticles comprise copper-based nanoparticles having a monodisperse particle size from 1 to 8 nm. This provides for a high surface area and thus a high reactivity in the adsorbing as well as in the regeneration reaction, respectively.

A further embodiment according to the present invention relates to a process for H₂S removal from a gas stream, wherein the yolk-shell nanoparticles comprise a relative amount by weight of copper-based nanoparticles relative to the total weight of the yolk-shell nanoparticles of 25 to 99 w.t.-%, preferably 40 to 99 w.t.-%, more preferably 50 to 99 w.t.-%, even more preferably 60 to 99 w.t.-% and most preferably 65 to 99 w.t.-%. A preferred embodiment according to the present invention relates to a process for H₂S removal from a gas stream, wherein the yolk-shell nanoparticles comprise a relative amount by weight of copper-based nanoparticles relative to the total weight of the yolk-shell nanoparticles of 65 to 99 w.t.-%. This provides for a process for H₂S removal from a gas stream, wherein yolk-shell nanoparticles allow for balancing out reactivity, i.e. activity and selectivity, and stability towards sintering. In other words, this provides for a process for H₂S removal from a gas stream, wherein both high H₂S adsorption capacities during H₂S adsorption from a gas stream on the one hand and high stability towards sintering during regeneration at the other are provided at the same time.

A further embodiment according to the present invention relates to a process for H₂S removal from a gas stream, wherein the yolk-shell nanoparticles provide for a H₂S adsorption capacity per amount of yolk-shell nanoparticles at temperatures ranging from 25 to 150° C. and H₂S concentrations of 1 to 1400 ppm , preferably at a temperature of 150° C. and an H₂S concentration of 100 ppm, of at least 2 mmol/g, preferably of at least 4 mmol/g, more preferably of at least 6 mmol/g, even more preferably of at least 8 mmol/g,and most preferably of at least 10 mmol/g.

Yet another embodiment according to the present invention relates to a process for H₂S removal from a gas stream, wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of at least 2 mmol/g_{CuO}, preferably of at least 4 mmol/g_{CuO}, more preferably of at least 6 mmol/g_{CuO}, even more preferably of at least 8 mmol/g_{CuO}, and most preferably of at least 10 mmol/g_{CuO}.

A further embodiment according to the present invention relates to a process for H₂S removal from a gas stream, wherein the yolk-shell nanoparticles comprise copper oxide nanoparticles having a monodisperse particle size from 1 to 50 nm, preferably from 1 to 30 nm, more preferably from 1 to 20 nm, even more preferably from 1 to 15 nm, most preferably from 1 to 8 nm, and wherein the yolk-shell nanoparticles comprise a relative amount by weight of copper-based nanoparticles relative to the total weight of the yolk-shell nanoparticles of 25 to 99 w.t.-%, preferably 40 to 99 w.t.-%, more preferably 50 to 99 w.t.-%, even more preferably 60 to 99 w.t.-% and most preferably 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of at least 2 mmol/g_{CuO}, preferably of at least 4 mmol/g_{CuO}, more preferably of at least 6 mmol/g_{CuO}, even more preferably of at least 8 mmol/g_{CuO}, and most preferably of at least 10 mmol/g_{CuO}, or any combination thereof. A preferred embodiment according to the present invention relates to a process for H₂S removal from a gas stream, wherein the yolk-shell nanoparticles comprise copper oxide nanoparticles having a monodisperse particle size from 1 to 20 nm, wherein the yolk-shell nanoparticles comprise a relative amount by weight of copper-based nanoparticles relative to the total weight of the yolk-shell nanoparticles of 60 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 2 mmol/g_{CuO}. A more preferred embodiment according to the present invention relates to a process for H₂S removal from a gas stream, wherein the yolk-shell nanoparticles comprise copper oxide nanoparticles having a monodisperse particle size from 1 to 15 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell at temperatures ranging from 25 to 150° C. and H₂S concentrations of 1 to 1400 ppm , preferably at a temperature of 150° C. and an H₂S concentration of 100 ppm, of least 4 mmol/g_{CuO}. An even more preferred embodiment according to the present invention relates to a process for H₂S removal from a gas stream, wherein the yolk-shell nanoparticles comprise copper oxide nanoparticles having a monodisperse particle size from 1 to 15 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 8 mmol/g_{CuO}. A most preferred embodiment according to the present invention relates to a process for H₂S removal from a gas stream, wherein the yolk-shell nanoparticles comprise copper oxide nanoparticles having a monodisperse particle size from 1 to 8 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 10 mmol/g_{CuO}.

A further embodiment according to the present invention relates to a process for H₂S removal from a gas stream, wherein after the regeneration the yolk-shell nanoparticles do not exhibit substantially reduced H₂S adsorption capacity in comparison to their original H₂S adsorption capacity. Another embodiment according to the present invention relates to a process for H₂S removal from a gas stream, wherein after the regeneration the yolk-shell nanoparticles exhibit an H₂S adsorption capacity which is substantially the same as their original H₂S adsorption capacity. Yet another embodiment according to the present invention relates to a process for H₂S removal from a gas stream, wherein after the regeneration the yolk-shell nanoparticles exhibit H₂S adsorption capacity which is in comparison to the original H₂S adsorption capacity not reduced more than 75%, preferably not more than 30%, more preferably not more than 20%, even more preferably not more than 10%, and most preferably not more than 5%. A further embodiment according to the present invention relates to a process for H₂S removal from a gas stream, wherein after the fifth, preferably after the forth, more preferably after the third, even more preferably after the second, most preferably after the first regeneration a stabilized H₂S adsorption capacity that corresponds to at least 35%, preferably 70%, more preferably at least 80%, even more preferably at least 90%, most preferably at least 95% of the initial H₂S adsorption capacity is reached.

A further embodiment according to the present invention relates to the use of yolk-shell nanoparticles in a process for H₂S removal from a gas stream comprising the steps of:
(i) Adsorbing H₂S from a gas stream comprising H₂S using yolk-shell nanoparticles according to the present invention, wherein the yolk-shell nanoparticles are exposed to the H₂S-comprising gas stream until the H₂S-absorbance capacity of the yolk-shell nanoparticles is reached; and, optionally
(ii) regenerating the yolk-shell nanoparticles, wherein the yolk-shell nanoparticles are heated in an oxidant stream until the respective metal oxide nanoparticles residing in the hollow spheres of the yolk-shell nanoparticles is regenerated, which efficiently adsorbs H₂S from gas streams again.

Another embodiment according to the present invention relates to the use of yolk-shell nanoparticles in a process for H₂S removal from a gas stream comprising both steps (i) and (ii), wherein in step (ii) the yolk-shell nanoparticles are heated in an oxidant stream to a temperature of at least 500° C., preferably of at least 550° C., more preferably of at least 650° C., even more preferably of at least 700° C. and most preferably of at least 600° C.

A further embodiment according to the present invention relates to the use of yolk-shell nanoparticles in a process for H₂S removal from a gas stream comprising both steps (i) and (ii), wherein in step (ii) the yolk-shell nanoparticles are heated in an oxidant stream for 1 hour, preferably for more than 1 hour, more preferably for more than 6 hours, and most preferably for 7 hours.

A preferred embodiment according to the present invention relates to the use of yolk-shell nanoparticles in a process for H₂S removal from a gas stream comprising both steps (i) and (ii), wherein in step (ii) the yolk-shell nanoparticles are heated in an oxidant stream to a temperature of 600° C. for 7 hours.

A most preferred embodiment according to the present invention relates to the use of yolk-shell nanoparticles in a process for H₂S removal from a gas stream comprising the steps of:
(iii) Adsorbing H₂S from a gas stream comprising H₂S using yolk-shell nanoparticles according to the present invention, wherein the yolk-shell nanoparticles are exposed to the H₂S-comprising gas stream until the H₂S-absorbance capacity of the yolk-shell nanoparticles is reached; and, optionally
(iv) regenerating the yolk-shell nanoparticles, wherein the yolk-shell nanoparticles are heated to a temperature of 600° C. in an oxidant stream for ₇ hours until the respective metal oxide nanoparticles residing in the hollow spheres of the yolk-shell nanoparticles is regenerated, which efficiently adsorbs H₂S from gas streams again.

Another embodiment according to the present invention relates to the use of yolk-shell nanoparticles in a process for H₂S removal from a gas stream comprising both steps (i) and (ii), wherein in step (ii) the oxidant stream comprises an oxidant gas or gas mixture, preferably wherein the oxidant gas or gas mixture comprises oxygen, most preferably wherein the oxidant stream is air.

An embodiment according to the present invention relates to the use of yolk-shell nanoparticles in a process for H₂S removal from a gas stream, wherein the yolk-shell nanoparticles comprise a mesoporous silica shell and copper-based nanoparticles, such as copper oxide, copper sulfide, copper sulfate, and/or copper hydroxide nanoparticles, wherein the copper-based nanoparticles are contained by said shell and wherein there is a void space between the shell and the copper-based nanoparticles.

Another embodiment according to the present invention relates to the use of yolk-shell nanoparticles in a process for H₂S removal from a gas stream, wherein the yolk-shell nanoparticles comprise copper oxide nanoparticles. In another embodiment relating to the use of yolk-shell nanoparticles in a process for H₂S removal from a gas stream according to the present invention, the yolk-shell nanoparticles comprise copper sulfide nanoparticles. In another embodiment relating to the use of yolk-shell nanoparticles in a process for H₂S removal from a gas stream according to the present invention, the yolk-shell nanoparticles comprise copper sulfate nanoparticles. In another embodiment relating to the use of yolk-shell nanoparticles in a process for H₂S removal from a gas stream according to the present invention, the yolk-shell nanoparticles comprise copper hydroxide nanoparticles. In a preferred embodiment relating to the use of yolk-shell nanoparticles in a process for H₂S removal from a gas stream according to the present invention, the yolk-shell nanoparticles comprise copper oxide nanoparticles. Copper oxide nanoparticles are highly reactive towards H₂S and form copper sulfate. Consequently, the process for H₂S removal from a gas stream according to the present invention, allows for high H₂S adsorption capacities.

A further embodiment according to the present invention relates to the use of yolk-shell nanoparticles in a process for H₂S removal from a gas stream, wherein the yolk-shell nanoparticles comprise copper-based nanoparticles having monodisperse particle sizes. Another embodiment according to the present invention relates to the use of yolk-shell nanoparticles in a process for H₂S removal from a gas stream, wherein the yolk-shell nanoparticles comprise copper-based nanoparticles having a monodisperse particle size from 1 to 50 nm, preferably from 1 to 30 nm, more preferably from 1 to 20 nm, even more preferably from 1 to 15 nm, and/or most preferably from 1 to 8 nm. A preferred embodiment according to the present invention relates to the use of yolk-shell nanoparticles in a process for H₂S removal from a gas stream, wherein the yolk-shell nanoparticles comprise copper-based nanoparticles having a monodisperse particle size from 1 to 15 nm. An even more preferred embodiment according to the present invention relates to the use of yolk-shell nanoparticles in a process for H₂S removal from a gas stream, wherein the yolk-shell nanoparticles comprise copper-based nanoparticles having a monodisperse particle size from 1 to 8 nm. This provides for a high surface area and thus a high reactivity in the adsorbing as well as in the regeneration reaction, respectively.

A further embodiment according to the present invention relates to the use of yolk-shell nanoparticles in a process for H₂S removal from a gas stream, wherein the yolk-shell nanoparticles comprise a relative amount by weight of copper-based nanoparticles relative to the total weight of the yolk-shell nanoparticles of 25 to 99 w.t.-%, preferably 40 to 99 w.t.-%, more preferably 50 to 99 w.t.-%, even more preferably 60 to 99 w.t.-% and most preferably 65 to 99 w.t.-%. A preferred embodiment according to the present invention relates to the use of yolk-shell nanoparticles in a process for H₂S removal from a gas stream, wherein the yolk-shell nanoparticles comprise a relative amount by weight of copper-based nanoparticles relative to the total weight of the yolk-shell nanoparticles of 65 to 99 w.t.-%. This provides for a process for H₂S removal from a gas stream, wherein yolk-shell nanoparticles allow for balancing out reactivity, i.e. activity and selectivity, and stability towards sintering. In other words, this provides for a process for H₂S removal from a gas stream, wherein both high H₂S adsorption capacities during H₂S adsorption from a gas stream on the one hand and high stability towards sintering during regeneration at the other are provided at the same time.

A further embodiment according to the present invention relates to the use of yolk-shell nanoparticles in a process for H₂S removal from a gas stream, wherein the yolk-shell nanoparticles provide for a H₂S adsorption capacity per amount of yolk-shell nanoparticles at temperatures ranging from 25 to 150° C. and H₂S concentrations of 1 to 1400 ppm , preferably at a temperature of 150° C. and an H₂S concentration of 100 ppm, of at least 2 mmol/g, preferably of at least 4 mmol/g, more preferably of at least 6 mmol/g, even more preferably of at least 8 mmol/g and most preferably of at least 10 mmol/g.

Yet another embodiment according to the present invention relates to the use of yolk-shell nanoparticles in a process for H₂S removal from a gas stream, wherein the yolk-shell nanoparticles provide for a H₂S adsorption capacity per amount of copper oxide nanoparticles comprised by the yolk-shell at temperatures ranging from 25 to 150° C. and H₂S concentrations of 1 to 1400 ppm , preferably at a temperature of 150° C. and an H₂S concentration of 100 ppm, of at least 2 mmol/g_{CuO}, preferably of at least 4 mmol/g_{CuO}, more preferably of at least 6 mmol/g_{CuO}, even more preferably of at least 8 mmol/g_{CuO}, and most preferably of at least 10 mmol/g_{CuO}.

A further embodiment according to the present invention relates to the use of yolk-shell nanoparticles in a process for H₂S removal from a gas stream, wherein the yolk-shell nanoparticles comprise copper oxide nanoparticles having a monodisperse particle size from 1 to 50 nm, preferably from 1 to 30 nm, more preferably from 1 to 20 nm, even more preferably from 1 to 15 nm, most preferably from 1 to 8 nm, and wherein the yolk-shell nanoparticles comprise a relative amount by weight of copper-based nanoparticles relative to the total weight of the yolk-shell nanoparticles of 25 to 99 w.t.-%, preferably 40 to 99 w.t.-%, more preferably 50 to 99 w.t.-%, even more preferably 60 to 99 w.t.-% and most preferably 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of at least 2 mmol/g_{CuO}, preferably of at least 4 mmol/g_{CuO}, more preferably of at least 6 mmol/g_{CuO}, even more preferably of at least 8 mmol/g_{CuO}, and most preferably of at least 10 mmol/g_{CuO}, or any combination thereof. A preferred embodiment according to the present invention relates to the use of yolk-shell nanoparticles in a process for H₂S removal from a gas stream, wherein the yolk-shell nanoparticles comprise copper oxide nanoparticles having a monodisperse particle size from 1 to 20 nm, wherein the yolk-shell nanoparticles comprise a relative amount by weight of copper-based nanoparticles relative to the total weight of the yolk-shell nanoparticles of 60 to 99 w.t.-% , and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 2 mmol/g_{CuO}. A more preferred embodiment according to the present invention relates to the use of yolk-shell nanoparticles in a process for H₂S removal from a gas stream, wherein the yolk-shell nanoparticles comprise copper oxide nanoparticles having a monodisperse particle size from 1 to 15 nm, wherein the yolk-shell nanoparticles comprise a relative amount by weight of copper-based nanoparticles relative to the total weight of the yolk-shell nanoparticles of 65 to ₉₉ w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 4 mmol/g_{CuO}. An even more preferred embodiment according to the present invention relates to the use of yolk-shell nanoparticles in a process for H₂S removal from a gas stream, wherein the yolk-shell nanoparticles comprise copper oxide nanoparticles having a monodisperse particle size from 1 to 15 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 8 mmol/g_{CuO}. A most preferred embodiment according to the present invention relates to the use of yolk-shell nanoparticles in a process for H₂S removal from a gas stream, wherein the yolk-shell nanoparticles comprise copper oxide nanoparticles having a monodisperse particle size from 1 to 100 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 10 mmol/g_{CuO}.

A further embodiment according to the present invention relates to the use of yolk-shell nanoparticles in a process for H₂S removal from a gas stream, wherein after the regeneration the yolk-shell nanoparticles do not exhibit substantially reduced H₂S adsorption capacity in comparison to their original H₂S adsorption capacity. Another embodiment according to the present invention relates to the use of yolk-shell nanoparticles in a process for H₂S removal from a gas stream, wherein after the regeneration the yolk-shell nanoparticles exhibit an H₂S adsorption capacity which is substantially the same as their original H₂S adsorption capacity. Yet another embodiment according to the present invention relates to the use of yolk-shell nanoparticles in a process for H₂S removal from a gas stream, wherein after the regeneration the yolk-shell nanoparticles exhibit an H₂S adsorption capacity which is in comparison to the original H₂S adsorption capacity not reduced more than 75%, preferably not more than 30%, more preferably not more than 20%, even more preferably not more than 10%, and most preferably not more than 5%. A further embodiment according to the present invention relates to the use of yolk-shell nanoparticles in a process for H₂S removal from a gas stream, wherein after the fifth, preferably after the forth, more preferably after the third, even more preferably after the second, most preferably after the first regeneration a stabilized H₂S adsorption capacity that corresponds to at least 35%, preferably 70%, more preferably at least 80%, even more preferably at least 90%, most preferably at least 95% of the initial H₂S adsorption capacity is reached.

A more preferred embodiment according to the present invention relates to the use of yolk-shell nanoparticles in a process for H₂S removal from a gas stream, wherein the yolk-shell nanoparticles comprise copper oxide nanoparticles having a monodisperse crystallites size from 1 to 15 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 4 mmol/g, and wherein after the regeneration the yolk-shell nanoparticles exhibit an H₂S adsorption capacity which is in comparison to the original H₂S adsorption capacity not reduced more than 30%.

A more preferred embodiment according to the present invention relates to the use of yolk-shell nanoparticles in a process for H₂S removal from a gas stream, wherein the yolk-shell nanoparticles comprise copper oxide nanoparticles having a monodisperse particle size from 1 to 15 nm, wherein the yolk-shell nanoparticles comprise a relative amount by weight of copper-based nanoparticles relative to the total weight of the yolk-shell nanoparticles of 65 to 99 w.t.-%, and wherein the yolk-shell nanoparticles provide for a H₂S adsorption capacity per amount of copper oxide nanoparticles comprised by the yolk-shell nanoparticles at temperatures ranging from 25 to 150° C. and H₂S concentrations of 1 to 1400 ppm , preferably at a temperature of 150° C. and an H₂S concentration of 100 ppm, of least 4 mmol/g_{CuO}, and wherein after the regeneration the yolk-shell nanoparticles exhibit an H₂S adsorption capacity which is in comparison to the original H₂S adsorption capacity not reduced more than 20%.

### EXAMPLES

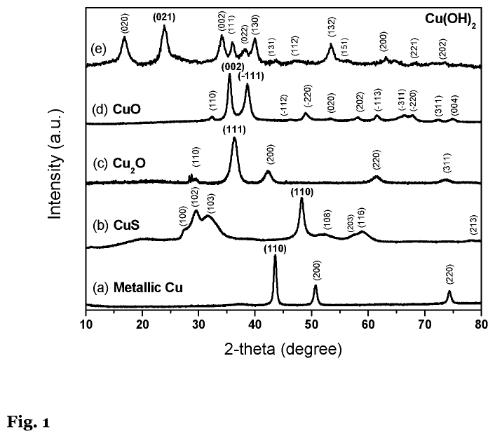

Various copper-based precursors such as metallic Cu, copper oxide (Cu₂O, CuO) or copper sulfide (CuS) can be prepared in organic solvents such as aliphatic amines (FIG. 1). Copper hydroxide (Cu(OH)₂) nanoparticles as copper-based precursors can be prepared in water (FIG. 1). Control of reaction parameters comprising choice of solvents, starting materials, surfactants, reaction temperature and pH allow for controlled synthesis of specific copper-based precursors. In the following several synthetic procedures for manufacturing yolk-shell nanoparticles according to the present invention and H₂S adsorption capacities of the same will be described.

### Example 1—Synthesis of Yolk-shell Nanoparticles Comprising Copper Oxide Nanoparticles—Step (i): Providing Copper Oxide Nanoparticles as Copper-based Precursors in Organic Solvents

Copper oxide nanoparticles as copper-based precursors for the synthesis of yolk-shell nanoparticles according to the present invention were prepared by thermal decomposition of copper(I) acetate in trioctylamine (TOA) and tetradecylphosphonic acid (TDPA). The isolated nanoparticles were of spherical shape, and the average size of the nanoparticles was dependent on the concentration of Cu(I) acetate and TPDA, as analyzed by TEM (FIG. 2). Average diameters of the obtained copper oxide nanoparticles were between 5 and 20 nm.

Thermal decomposition of copper acetyl acetonate, (Cu(acac)₂) as copper-based starting material in oleyl amine at temperatures of 150 to 250° C. in air leads to the formation of cuprite (Cu₂O) nanoparticles. Employing an atmosphere of an inert gas such as argon at temperatures of 200 to 280° C. leads to the formation of metallic Cu nanoparticles as copper-based precursors. Copper sulfides (CuSₓ) as copper-based precursors can be synthesized from copper acetyl acetonate, (Cu(acac)₂) as starting material by the addition of elemental sulfur under vigorous stirring in an atmosphere of an inert gas such as argon at temperatures of 100-250° C.

Using trioctyl amine (TOA) as a solvent, the thermally decomposition of copper acetate in the presence of tetradecyl sulfonate leads to the formation of CuO nanoparticles having a particle size of ₄nm. CuO nanoparticles having larger particle sizes can be prepared by using higher amounts of precursors and TDPA (FIG. 2).

### Example 2—Synthesis of Yolk-shell Nanoparticles Comprising Copper Oxide Nanoparticles—Step (ii): Forming a Silica-shell Around the Copper-based Precursor from Example 1 in Ethanol

The copper-based precursors from Example 1, i.e. the copper oxide nanoparticles were reacted with tetraethylorthosilicate (TEOS), Si(OEt)₄, in the presence of cetyltrimethylammonium bromide (CTAB), where in ethanol was used as solvent. Electron microscopic images of the so obtained reaction product are shown in Fig. ₃. As can be seen, the copper-based precursors, i.e. the copper oxide nanoparticles are efficiently encapsulated in hollow spheres of silica.

### Example 3—Synthesis of Yolk-shell Nanoparticles Comprising Copper Oxide Nanoparticles—Step (iii): Thermally Treating the Reaction Product of Example 2 (Calcination of the Copper Oxide Nanoparticles Encapsulated in Hollow Spheres of Silica)

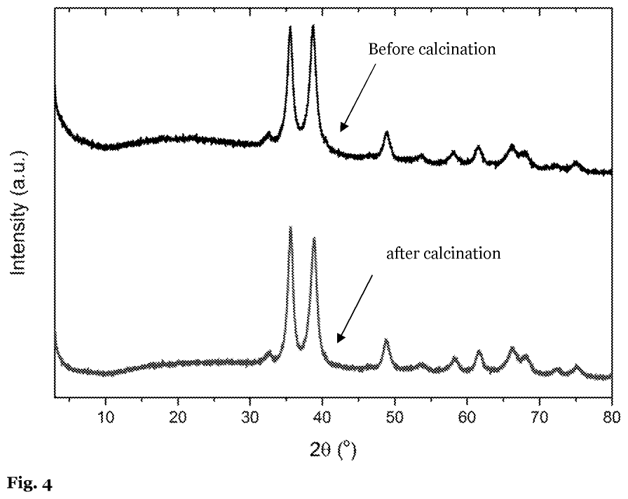

Yolk-shell nanoparticles according to the present invention were prepared by thermally treating the reaction product provided in Example 2, i.e. calcination of the copper oxide nanoparticles encapsulated in hollow spheres of silica at 450° C. for 5 h. The calcination reaction was also used to simulate the regeneration reaction of the yolk-shell nanoparticles which already underwent the adsorption reaction with H₂S. After calcination, the samples were analyzed by diffraction pattern and electron microscopic analysis. The diffraction pattern of the samples before calcination and after calcination is shown in FIG. 4.

The morphology of the yolk-shell nanoparticles did not change during calcination, confirming that sintering was effectively prevented.

### Example 4—Synthesis of Yolk-shell Nanoparticles Comprising Copper Oxide Nanoparticles—Steps (ii) and (iii): Forming a Silica-shell Around the Copper-Based Precursor from Example 1 in Water and Subsequent Calcination

The copper-based precursors, i.e. the copper oxide nanoparticles as obtained by the synthesis described in Example 1, were subjected to a reaction for formation of the silica shell around the copper-based precursors, wherein said copper-based precursors, i.e. the copper oxide nanoparticles as obtained in Example 1 were reacted with tetraethylorthosilicate (TEOS), Si(OEt)₄, in the presence of cetyltrimethylammonium bromide (CTAB). In this case, water was used as solvent instead of ethanol.

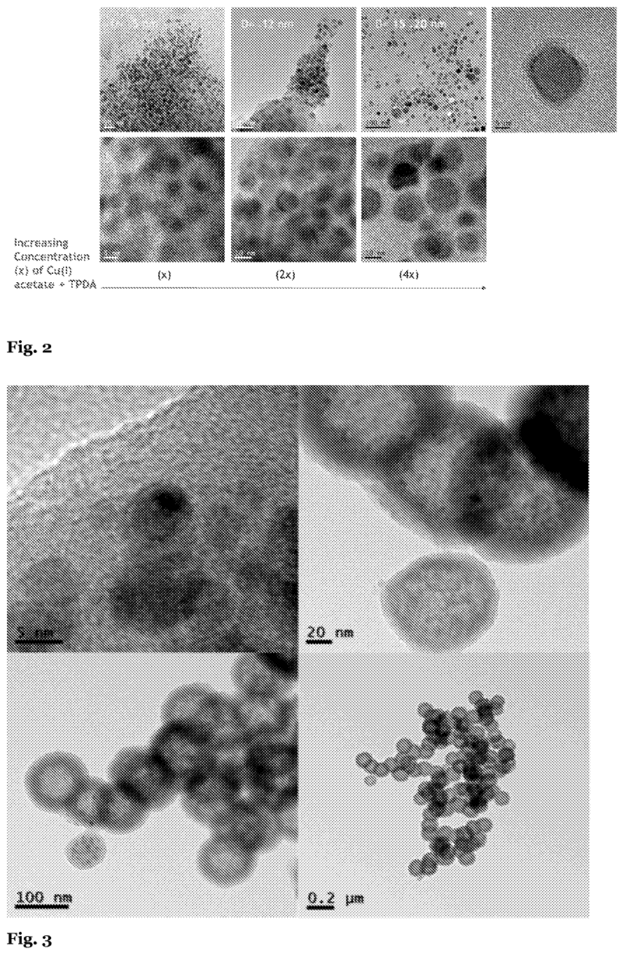

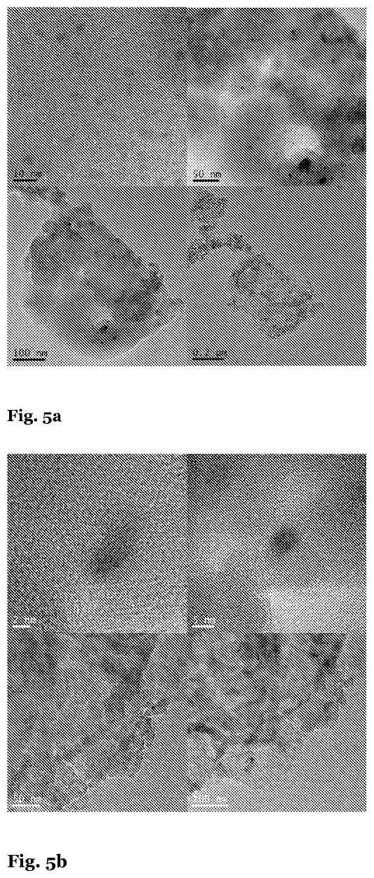

Electron microscopic images of the so obtained reaction product are shown in FIGS. 5a and 5b. As can be seen, in comparison to the uniformly shaped reaction product of Example 2 (FIG. 3), the product obtained via the reaction with the silica precursor in water exhibits a broader particle size distribution, and, furthermore, and also bulk silica aggregates form as side products.

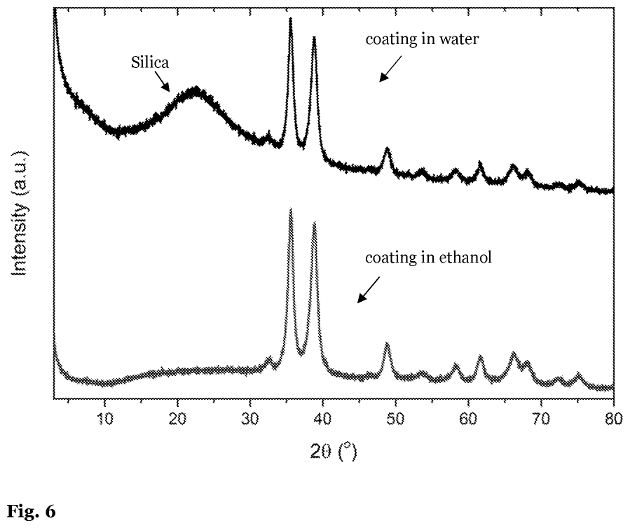

This was confirmed by diffraction pattern analysis of the reaction product obtained in Example 3 in comparison to the reaction product obtained in Example 2, as shown in FIG. 6.

Accordingly, formation of the silica shell around the copper-based precursors is preferably performed in ethanol.

### Example 5—Preparation of Yolk-shell Nanoparticles Comprising Copper Sulfide Nanoparticles

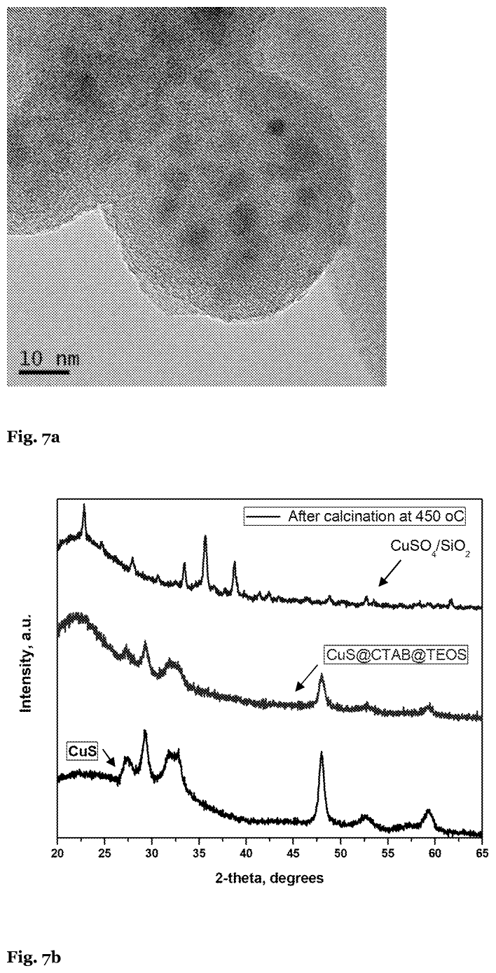

Yolk-shell nanoparticles comprising copper sulfate nanoparticles were prepared by forming the mesoporous silica shell around the copper-based precursors (CuSₓ nanoparticles) via a reaction employing CTAB and TEOS and subsequent thermal treatment (calcination) at 450° C. for 5 h as described above. The morphology of the resulting yolk-shell nanoparticles comprising copper sulfate nanoparticles was studied by microscopy (FIG. 7a), and by diffraction pattern analysis (FIG. 7b). As can be seen in FIG. 6, the mesoporous silica shell was successfully formed around the copper sulfate nanoparticles. Further, the silica shell prevented any sintering reaction (FIG. 7b, top trajectory).

### Comparative Example 6—Calcination of Nanoparticles Without Silica Shell

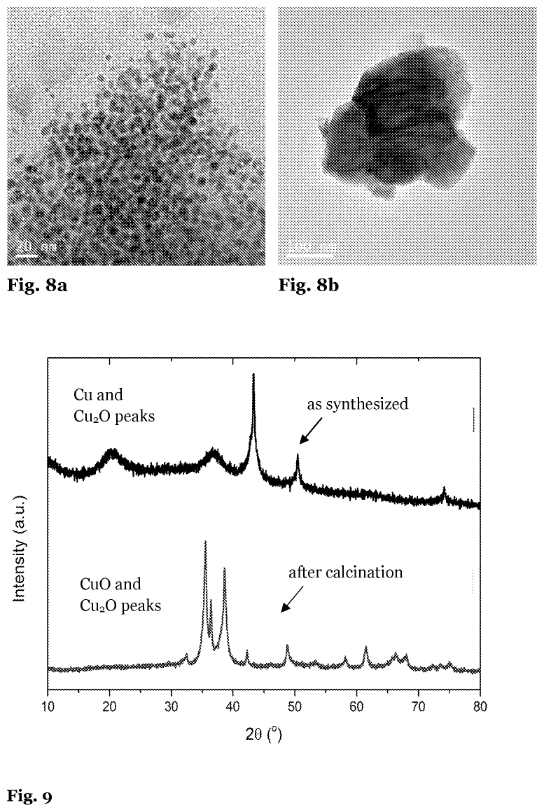

Nanoparticles without silica shell as obtained in Example 1 were subjected to a calcination reaction at 450° C. for 5 h, and the morphology of the samples was subsequently analyzed by means of microscopic analysis (FIG. 8a, b) and diffraction pattern analysis (Fig. ₉). The morphology changed considerably. In particular, comparing FIG. 8a, showing the morphology of the nanoparticles before calcination, and FIG. 8b, showing the morphology of the nanoparticles after calcination, indicates that the nanoparticles agglomerated to large aggregates.

### Example 7—H₂S Adsorption

H₂S adsorption was performed in a fixed bed U-shaped quartz reactor. 10 mg of the yolk shell nanoparticles were mixed with 200 mg of quartz particles after sieving, and the mixture was pretreated at 350° C. for five hours under argon to remove any water and organic solvents.

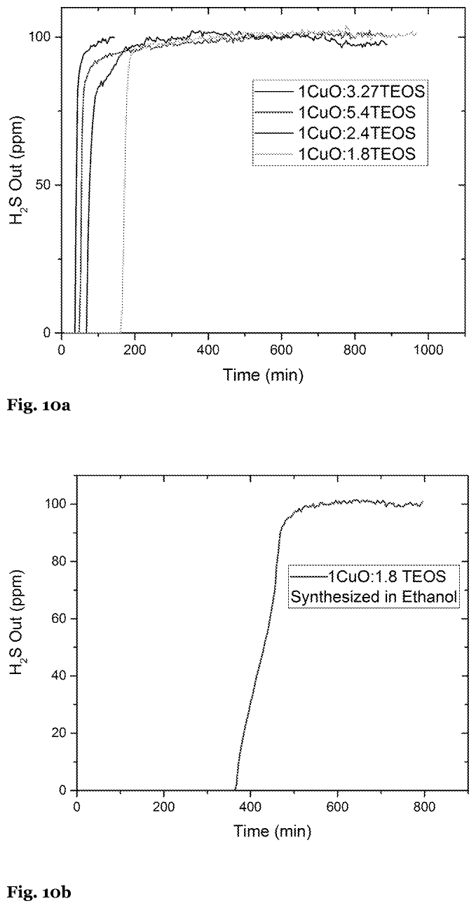

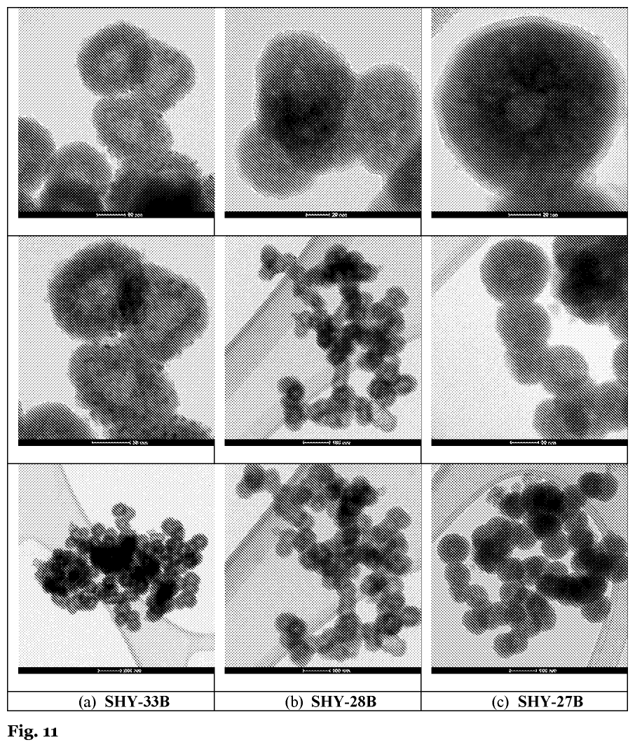

Subsequently, a nitrogen stream comprising 100 ppm H₂S was passed through the reactor at ₁₅₀° C. and at atmospheric pressure, and the respective H₂S breakthrough curves at concentrations of ₅ ppm H₂S were obtained. After the H₂S breakthrough, the system was purged with argon to flush out any remaining H₂S. Exemplary breakthrough curves are shown for yolk-shell nanoparticles comprising copper oxide nanoparticles, the mesoporous silica shell either obtained in water (FIG. 10a) or in ethanol (FIG. 10b).

The sulfur capacity of the different samples, as measured by breakthrough analysis, is summarized in table 1. The samples were prepared with different mole-to-mole ratios of copper-based precursors to TEOS.

TABLE 1
H₂S adsorption capacity of copper oxide nanoparticles
without silica shell and yolk-shell nanoparticles
comprising copper oxide nanoparticles.

| | H₂S adsorption |
|---|---|
| | capacity |
| | (mmol/g) |
| 1. CuO w/o silica shell | |
| synthesized in oleylamine | 0.27 |
| synthesized in trioctylamine | 0.29 |
| 2. CuO yolk-shell nanoparticles synthesized in ethanol | |
| 1 CuO:1.8 TEOS | 6.90 |
| 3. CuO yolk-shell nanoparticles synthesized in water | |
| 1 CuO:5.4 TEOS | 0.82 |
| 1 CuO:3.27 TEOS | 0.60 |
| 1 CuO:2.4 TEOS | 1.16 |
| 1 CuO:1.8 TEOS | 2.76 |

The H₂S adsorption capacity was highest for the sample comprising 1 CuO : 1.8 TEOS, prepared in ethanol, as described above in Example 2. In contrast, nanoparticles without silica shell proved to be significantly inferior to the yolk-shell nanoparticles according to the invention.

### Example 8—Yolk-shell Nanoparticles with Various Relative Amounts of Copper-based Nanoparticles and Silica, and Influence on H₂S Capacities

Copper oxide precursors were prepared by the thermolytic synthesis route described in Example 1. The copper oxide precursors obtained had a mean particle size of around 4 nm. Those copper oxide precursors were subjected to the formation of the silica shell in ethanol as described in Example 2.

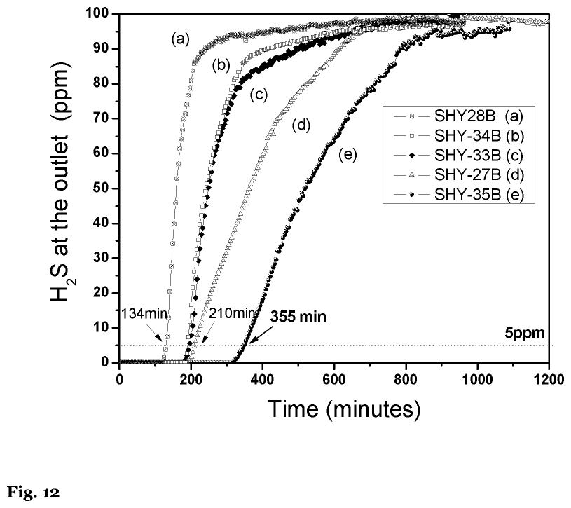

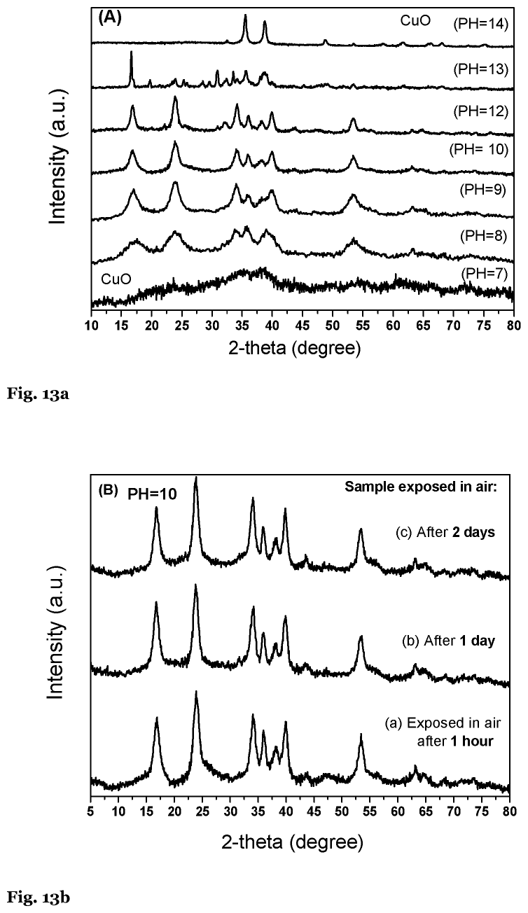

The relative amount of silica was varied by employing different amounts of CTAB and TEOS. Representative TEM images of exemplary yolk-shell nanoparticles with different relative amounts of silica are shown in FIG. 11. Subsequently H₂S adsorption was measured according to Example 7 (FIG. 12). The relationship between the relative amount of silica, the relative amounts by weight of copper-based (CuO) nanoparticles relative to the total weight of the yolk-shell nanoparticles and sulfur capacity is shown in Table 2.

TABLE 2
Sulfur capacity of yolk-shell nanoparticles comprising
4 nm CuO nanoparticles having different relative amounts
by weight of copper-based (CuO) nanoparticles relative
to the total weight of the yolk-shell nanoparticles.

| | | | | H₂S adsorption |
|---|---|---|---|---|
| | | | | capacity per amount |
| | | | | of CuO at 5 ppm |
| | | | | breakthrough |
| | CTAB | TEOS | CuO | concentration |
| Sample | (mg) | (μL) | (w.t. %) | (mmol/g_{CuO}) |
| SHY-35B | 1,000 | 300 | 81.9 | 5.89 |
| SHY-33B | 800 | 300 | 65.4 | 4.53 |
| SHY-27B | 600 | 100 | 72.3 | 3.45 |
| SHY-34B | 1,000 | 100 | 67.7 | 3.15 |
| SHY-28B | 600 | 200 | 51.7 | 2.73 |

These results suggest that a high relative amount by weight of copper-based (CuO) nanoparticles relative to the total weight of the yolk-shell nanoparticles results in a high sulfur capacity.

### Example 9—Synthesis of Yolk-shell Nanoparticles Comprising Copper Oxide Nanoparticles—Step (i): pH-dependent Synthesis of Cu(OH)₂ Nanoparticles as Copper-based Precursors in Water as Copper-based Precursors

A) Cu(OH)₂ Nanoparticles as Copper-based Precursors were Obtained from CuSO₄ as Precursor in Alkaline Aqueous Media (NaOH) Without the Presence of a Surfactant:

Cu(OH)₂ nanoparticles as copper-based precursors can be easily prepared in aqueous solutions under alkaline conditions using copper sulfate, specifically cupric sulfate pentahydrate, CuSO₄·5H₂O, as copper-based starting material and sodium hydroxide, NaOH, as a base. Copper sulfate reacts with sodium hydroxides to produce copper hydroxide and sodium sulfate according to the following equation:

CuSO₄+2NaOH→Cu(OH)₂(s)+Na₂SO₄ (Equation 1)

In a typical synthesis 4 mmol CuSO₄.5H₂O are dissolving in 100 ml de-ionized water (Mixture A) using a mechanical stirrer at room temperature. In a separate beaker an appropriate amount of sodium hydroxide (0.1-4 g NaOH) is dissolved in 50 ml de-ionized water (Mixture B). Subsequently, Mixture B is steadily added to Mixture A and the resulting mixture is mixed vigorously for 10 min, wherein a precipitate forms. The precipitate is separated by centrifugation at 4000 rpm for 10 min, following 2 washes for the removal of byproducts with ethanol and water, separated again by centrifugation at 4000 rpm for 10 min. Following this procedure various Cu-based yolk structures such as CuO, Cu(OH)₂ and mixtures thereof, dependent on the pH (7-14) of the reaction mixture were obtained.

In particular, as shown by XRD patterns (FIG. 13a and FIG. 13b), the Cu(OH)₂ nanoparticles' structure depends on the pH of the reaction medium. At high pH (pH=14) the reaction leads to the synthesis of CuO (FIG. 13a). Decreasing the pH, the structure obtained for pH larger than 10, (e.g. pH=12) is not stable. At pH=10 a stable Cu(OH)₂ structure having a crystallite size of 6.4 nm is obtained, which is also stable after exposure to air for 2 days (FIG. 13b). By further lowering the pH of the reaction medium, Cu(OH)₂ nanoparticles having smaller crystallite sizes were obtained for pH values ranging from 10 to 8 (e.g. compare to broadened peaks in XRD pattern of particles obtained at pH=8 in FIG. 13a). At pH=7, the reaction leads to the synthesis of very small (amorphous) CuO nanoparticles.

From these experimental data can be concluded that pure Cu(OH)₂ nanoparticles as copper-based precursors can be prepared at pH ranging from 8 to 12. The prepared Cu(OH)₂ nanoparticles as copper-based precursors varied in size depending on the pH of the reaction mixture. Specifically, the mean crystallite size based on Scherer equation was estimated from the main peak around 17°for Cu(OH)₂ nanoparticles: copper-based precursors prepared in alkaline environment with a pH value of 8, 10 and 12 have particle sizes of 3 nm, 6 nm and 11 nm, respectively. It was also found that crystalline CuO nanoparticles (tenorite structure) having particle sizes greater than 11 nm can be prepared at higher pH (>12). CuO nanoparticles prepared at lower pH (≤7) have smaller particles sizes (≤3 nm) and tend to be amorphous. The prepared Cu(OH)₂ copper-based precursors prepared at pH=10 are stable against oxidation in air.

B) Cu(OH)₂ Nanoparticles were Obtained from CuSO₄ as Precursor in Alkaline Aqueous Media (NaOH) in Presence of a Surfactant:

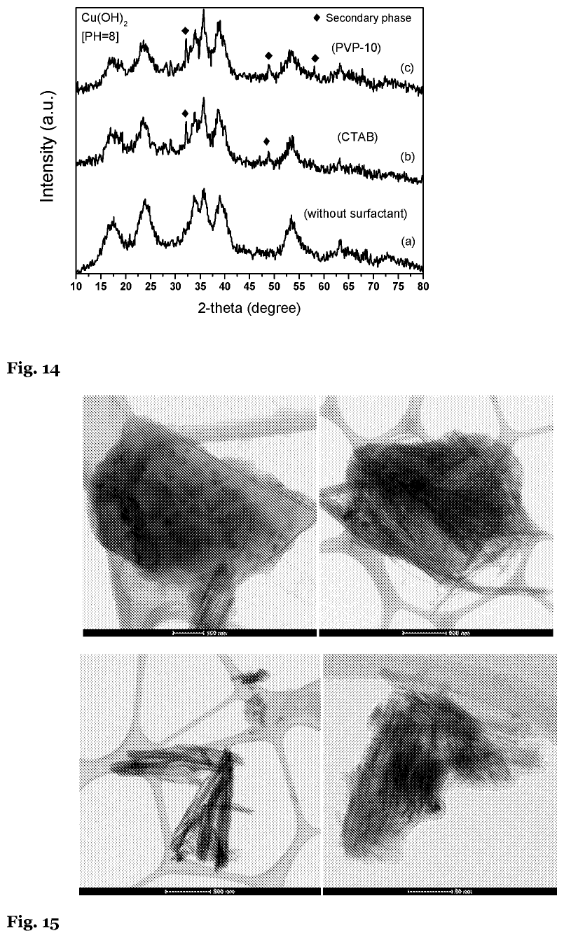

Cu(OH)₂ nanoparticles as copper-based precursors can also be prepared in the presence of surfactants such as cetyltrimethyl ammonium bromide (CTAB) or polyvinyl pyrrolidone having an average molecular weight of 10,000 g/mol (PVP-10 (FIG. 14). However, it was observed that in the presence of surfactants the formation of an unknown secondary copper phase is favored at moderate alkaline pH of 8. Accordingly, when using surfactant in the synthesis of Cu(OH)₂ nanoparticles as copper-based precursors a pH greater than 8, such as 9 to 10 is preferred.

### Example 10—Synthesis of Yolk-shell Nanoparticles Comprising Copper Oxide Nanoparticles via Copper Hydroxide Precursors—Step (ii) and (iii): Forming a Silica-shell Around the Copper Hydroxide Precursor from Example 9 in Different Solvents and Subsequent Thermal Treatment

A silica-shell was formed around the as-prepared Cu(OH)₂ nanoparticles as copper-based precursors from Example 9 employing tetraethyl orthosilicate (TEOS), Si(OEt)₄. The formation of the silica shell may be carried out with or without the presence of a surfactant (e.g. cetyltrimethylammonium bromide CTAB or polyvinyl pyrrolidone (PVP); FIG. 14) in (a) water without surfactant, (b) ethanol with CTAB as surfactant (Sample-36-3B) or (c) mixtures of water and ethanol with PVP-10 as surfactant (Sample-36-4B). The reaction product is further calcined at 450° C. for 2 hours.

### A) Forming a Silica-shell Around the Copper Hydroxide Precursor in the Presence of PVP as Surfactant

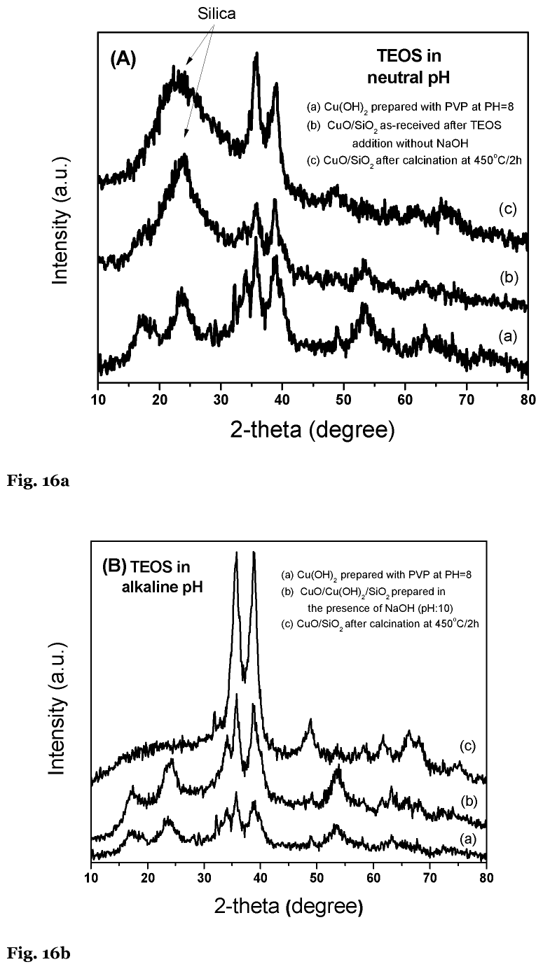

For example, the Cu(OH)₂ nanoparticles provided as copper-based precursor were dispersed in deionized water, following the drop wise addition of TEOS (500 μL) as a source of silica in neutral and alkaline environment. From FIG. 16a showing the XRD patterns of Cu(OH)₂ nanoparticles prepared in pH=8 in the presence of polyvinyl pyrrolidone (PVP) before (a) and after (b) the development of silica in neutral (A), cf. FIG. 16a, and alkaline environment (B), cf. FIG. 16b, it is concluded that more silica is produced in neutral environment, compared to alkaline conditions (pH=10). In addition, at neutral pH, the Cu(OH)₂ phase is transformed into a CuO phase. Under alkaline conditions (pH=10), only a part of the initial Cu(OH)₂ phase is transferred into a CuO phase, most probably due to the small particle size (˜3 nm) of Cu(OH)_{2.}

### B) Forming a Silica-shell Around the Copper Hydroxide Precursor in the Presence of CTAB as Surfactant

Based on the above findings, the synthesis of yolk-shell nanoparticles (Cu(OH)₂/SiO₂) in the presence of cetyl trimethylammonium bromide (CTAB) as surfactant was studied (FIG. 15). The synthesis was performed under alkaline conditions (pH=10) in the presence of different amounts of CTAB, cf. details in Table 3a (step (i)) and Table 3b (step (ii)).

TABLE 3a
Reaction conditions for the synthesis of yolk-shell nanoparticles
in water from Cu(OH)₂ nanoparticles as copper-based precursors in
the presence of various amounts of CTAB as a surfactant (step (i)).

| | Step (i): | | | | | |
|---|---|---|---|---|---|---|
| | CuSO₄ + ₂NaOH → Cu(OH)₂ (s) + Na₂SO₄ | | | | | |
| | Mixture A | | | | Mixture B | |
| | Solv. | Surfactant | | Precursor | Base | |
| SAMPLE | H₂O | CTAB | | CuSO₄ | NaOH | H₂O |
| SAD-6B | 100 ml | 0 | mg | 0.5 g | 0.5 g | 50 ml |
| SG-13B | | 400 | mg | | | |
| SAD-3B | | 400 | mg | | | |
| SAD-4B | | 400 | mg | | | |
| SAD-5B | | 1000 | mg | | | |

Samples from 1-5 are referred to composite materials of Cu(OH)₂/SiO₂, prepared in water in the presence of various amounts of CTAB at alkaline conditions (pH = 10).

TABLE 3b
Reaction conditions for the synthesis of yolk-shell nanoparticles in
water from Cu(OH)₂ nanoparticles as copper-based precursors in the
presence of various amounts of CTAB as a surfactant (step (ii)).

| Step (ii): | |
|---|---|
| Cu(OH)₂ (s) + TEOS + NaOH → Cu(OH)_{2/SiO2} | |
| Surfactant (CTAB) present! | |
| Mixture C | Mixture D |

| | | |
|---|---|---|
| Solvent | Surfactant | Base |

| SAMPLE | H₂O | CTAB | | NaOH | H₂O |
|---|---|---|---|---|---|
| SAD-6B | 100 mL | 0 | mg | 0.2 g | 50 ml |
| SG-13B | | 0 | mg | | |
| SAD-3B | | 100 | mg | | |
| SAD-4B | | 300 | mg | | |
| SAD-5B | | 100 | mg | | |

Samples from 1-5 are referred to composite materials of Cu(OH)₂/SiO₂, prepared in water in the presence of various amounts of CTAB at alkaline conditions (pH = 10).

The Cu(OH)₂ nanoparticles obtained from the synthesis in water (step 1; cf. Example 9) as copper-based precursors were redispersed in 100 ml water in which an additional amount of CTAB as surfactant was disolved, followed by drop wise addition of TEOS (500μL) as silica source by using an electronic pipette (Mixture C). Then, an aqueous solution of 0.2 g NaOH (Mixture D) was mixed with Mixture C and the reaction was left to react for 24 hours under stirring forming a precipitate. The precipitate was then isolated by centrifugation using 4500 rpm for 10 min following 4 washes with water and acetone. The samples were dried in a glass and collected as a powder. In a final step, the as prepared Cu(OH)₂ and Cu(OH)₂/SiO₂ powders were thermally treated (calcined) at a temperature of 450° C. for 2 hours using a heating rate of 2.5°C./min resulting in the removal of the surfactant (CTAB) from the mesopores of the silica shell.

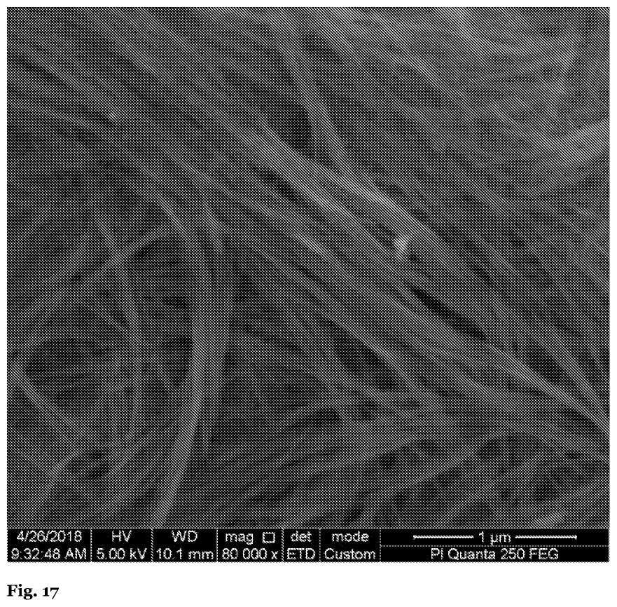

The Cu(OH)₂/SiO₂ composites prepared without any addition of the CTAB (SAD-6B) have a mean crystallite size of around 4 nm and have, upon thermal treatment, a relative amount by weight of copper-based (CuO) nanoparticles relative to the total weight of the Cu(OH)₂/SiO₂ composite of 83.8 w.t. % (FIG. 17).

When using CTAB as a surfactant in both steps, i.e. step (i) providing the copper-based precursor and step (ii) forming the silica shell, well-defined yolk-shell nanoparticles comprising CuO nanoparticles are obtained upon thermal treatment (samples SAD-3B and SAD-4B).

When tripling (×3) the amount of CTAB (×3) during the formation of the silica shell, the relative amount by weight of silica relative to the total weight of the yolk-shell nanoparticles is 21% w.t. (SAD-4B) in comparison to 6.9% w.t. (SAD-3B). Thus, increasing the amount of CTAB during the development of silica in water by three, leads to the proportionate increase of mesoporous silica. Increasing the amount of CTAB by 2.5 times during step (i) providing the copper-based precursor having a size of 13 nm leads after formation of the silica shell in step (ii) and thermal treatment in step (iii) to the formation of fine chains of yolk-shell nanoparticles comprising CuO nanoparticles having a size of 6 nm (SAD-5B).

### C) Forming a Silica-shell Around the Copper Hydroxide Precursor Without a Surfactant in Different Solvents

TABLE 4a
Reaction conditions for the synthesis of yolk-shell nanoparticles
in water from Cu(OH)₂ nanoparticles as copper-based precursors without
surfactant in water, ethanol and mixtures thereof (step (i)).

| | Step (i): | | | | |
|---|---|---|---|---|---|
| | CuSO₄ + ₂NaOH → Cu(OH)₂ (s) + Na₂SO₄ | | | | |
| | Mixture A | | | Mixture B | |
| | Solv. | Surfactant | Precursor | Base | |
| SAMPLE | H₂O | CTAB | CuSO₄ | NaOH | H₂O |
| 1 | 100 ml | 400 mg | 0.5 g | 0.5 g | 50 ml |
| 2 | | | | | |
| 3 | | | | | |
| (SG-15B) | | | | | |
| 4 | | | | | |
| (SG-16B) | | | | | |

In all samples 0.5 mL of TEOS were used as a silica source.

TABLE 4b
Reaction conditions for the synthesis of yolk-shell nanoparticles
in water from Cu(OH)₂ nanoparticles as copper-based precursors without
surfactant in water, ethanol and mixtures thereof (step (ii)).

| Step (ii): | |
|---|---|
| Cu(OH)₂ (s) + TEOS + NaOH → Cu(OH)_{2/SiO2} | |
| No Surfactant! | |
| Mixture C | Mixture D |

| | |
|---|---|
| Surfactant | Base |

| SAMPLE | Solvent | CTAB | NaOH | H₂O |
|---|---|---|---|---|
| 1 | H₂O | — | 0.2 g | 50 ml |
| | 100 mL | | | |
| 2 | H₂O/EtOH | | | |
| | (50/50 mL) | | | |
| 3 | EtOH | | | |
| (SG-15B) | 100 mL | | | |
| 4 | | | no | |
| (SG-16B) | | | NaOH! | |

In all samples 0.5 mL of TEOS were used as a silica source.

TABLE 4c
Different relative amounts by weight of copper oxide/silica relative
to the total weight of the yolk-shell nanoparticles resulting
from different reaction conditions as shown in Table 4a above.

| | | SiO₂ | CuO |
|---|---|---|---|
| SAMPLE | Reaction conditions step (ii) | (% w.t.) | (% w.t.) |
| 1 | H₂O + NaOH | 18.9 | 81.1 |
| 2 | H₂O/EtOH + NaOH | 22.2 | 77.8 |
| 3 | EtOH + NaOH | 49. | 51 |
| (SG-15B) | | | |
| 4 | EtOH; no NaOH | 1.2 | 98.8 |
| (SG-16B) | | | |

Tables 4a and 4b in combination with Table 4c show that the highest relative amounts by weight of silica relative to the total weight of the yolk-shell nanoparticles were achieved when the hydrolysis/condensation reactions of TEOS, step (ii), took place in ethanol in the presence of sodium hydroxide (sample 3; SG-15B). If no sodium hydroxide is employed in ethanol in step (ii), yolk-shell nanoparticles having high relative amounts by weight of copper oxide relative to the total weight of the yolk-shell nanoparticles of 98.8 w.t. % are formed (entry 4; Sample: SG-16B). Due to corresponding small amount of silica (only 1.2 w.t. % SiO₂ in the yolk-shell nanoparticles according to entry 4; Sample: SG-16B) the Cu(OH)₂ particles after calcination at 450° C./2 h, become larger, possessing crystallite size of around 10.5 nm (instead of 4 nm) during the synthesis of CuO/SiO₂ yolk structure.

### Example 11—Solvent Effects on Relative Amounts by Weight of Silica Shell and H₂S Adsorption Capacities

The yolk-shell nanoparticles obtained in Example 10 were subjected to powder XRD, SEM, and TEM analysis in order to show the effect of the different solvents used in Example 10 on the relative amounts by weight of copper oxide nanoparticles and the mesoporous silica shell. Further, the effect of different solvents on the H₂S adsorption capacities of the yolk-shell nanoparticles was analyzed.
a) Powder XRD, SEM, and TEM analysis

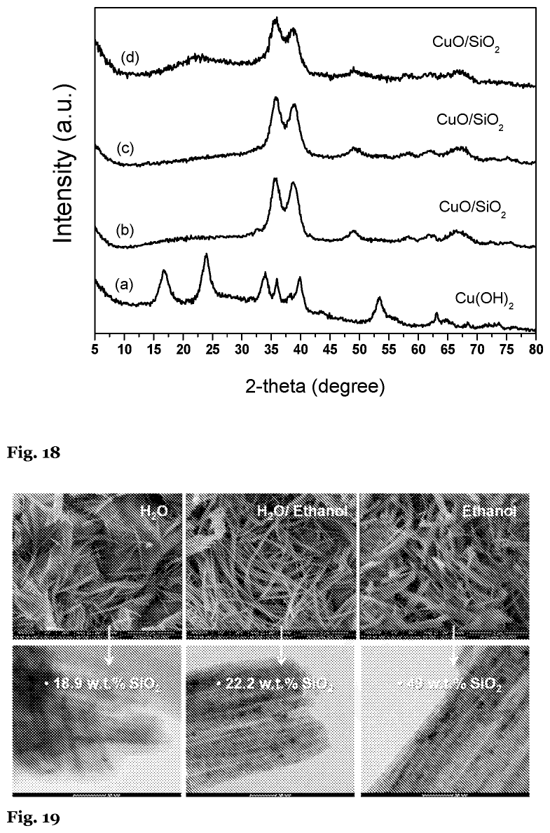

FIG. 18 shows the powder XRD patterns of (a) the as-prepared Cu(OH)₂ nanoparticles (according to Example 9) and (b-d) the yolk-shell nanoparticles after calcination at 450° C. for 2 hours. The formation of the silica shell in step 2 was conducted in different solvents: (b) in water, (c) in water/ethanol (1:1) and (d) ethanol. FIG. 19 displays SEM (top) and TEM (bottom) images of the yolk-shell nanoparticles prepared in various solvents and after calcination at 450° C. for 2 hours.

The SEM/EDS results show that when ethanol is used as solvent yolk-shell nanoparticles having a higher relative amount by weight of mesoporous silica shell are obtained (49 w.t. % SiO₂).
b) H₂S adsorption capacities for yolk-shell nanoparticles obtained from (a) water, (b) water/ethanol (1:1) and (c) ethanol without the presence of a surfactant

Furthermore, H₂S adsorption capacities (at 150° C. and 100 ppm H₂S in the gas inlet stream and at a breakthrough concentration of 5 ppm H₂S) were measured for yolk-shell nanoparticles having different relative amounts by weight of copper oxide nanoparticles. The copper oxide nanoparticles contained in the hollow mesoporous silica sphere had a mean crystallite size of 4.3 nm in all cases. The variation of the relative amounts by weight of copper oxide nanoparticles (w.t. %) was achieved by using different solvents or mixtures of solvents for the formation of the silica shell as described in Example 10, i.e. (a) water, (b) water/ethanol (1:1) and (c) ethanol (FIG. 20). The properties of the yolk-shell nanoparticles with various relative amounts by weight of copper oxide nanoparticles are summarized in Table 5.

TABLE 5
Properties of the yolk-shell nanoparticles with various
relative amounts by weight of copper oxide nanoparticles.

| | | H₂S | | H₂S |
|---|---|---|---|---|
| | | adsorption | Relative | adsorption |
| | Time *) | capacity #) | amount of CuO | capacity §) |
| Solvent | (min) | (mmol/g) | (% w.t.) | (mmol/g_{CuO}) |
| (a) Water | 520 | 8.505 | 81.1 | 10.48 |
| (b) Water/Ethanol | 387 | 6.232 | 77.8 | 8.01 |
| (c) Ethanol | 223 | 3.654 | 51 | 7.16 |

*) Time needed until H₂S breakthrough (min)
#) H₂S adsorption capacity at 5 ppm breakthrough concertation (mmol/g)
§) H₂S adsorption capacity per amount of CuO at 5 ppm breakthrough concertation (mmol/gCuO)

As Table 5 indicates, increasing the amount of water being present during the formation of the silica shell around the copper-based precursor leads to increased relative amounts by weight of copper-based (CuO) nanoparticles relative to the total weight of the yolk-shell nanoparticles, and thus also leads to higher sulfur capacities.

### Example 12—Size-dependent H₂S Adsorption Capacity

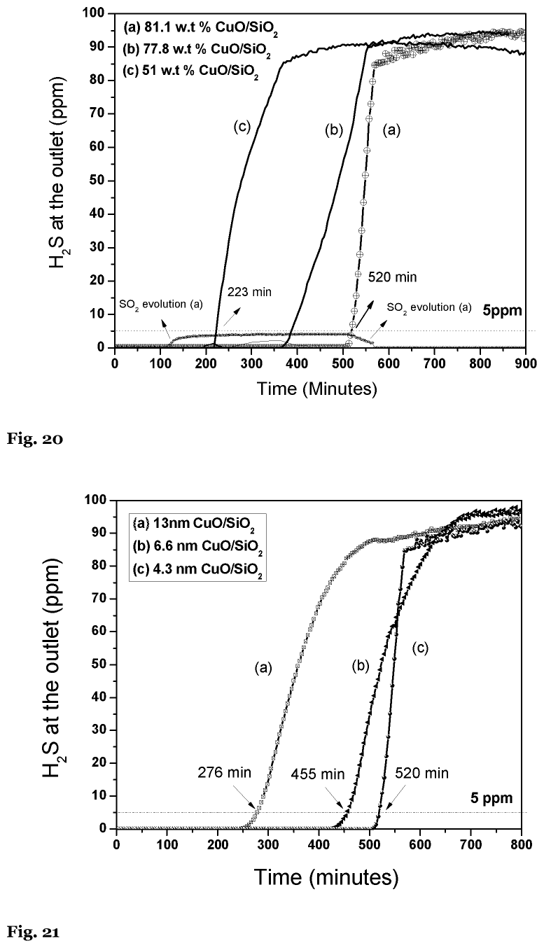

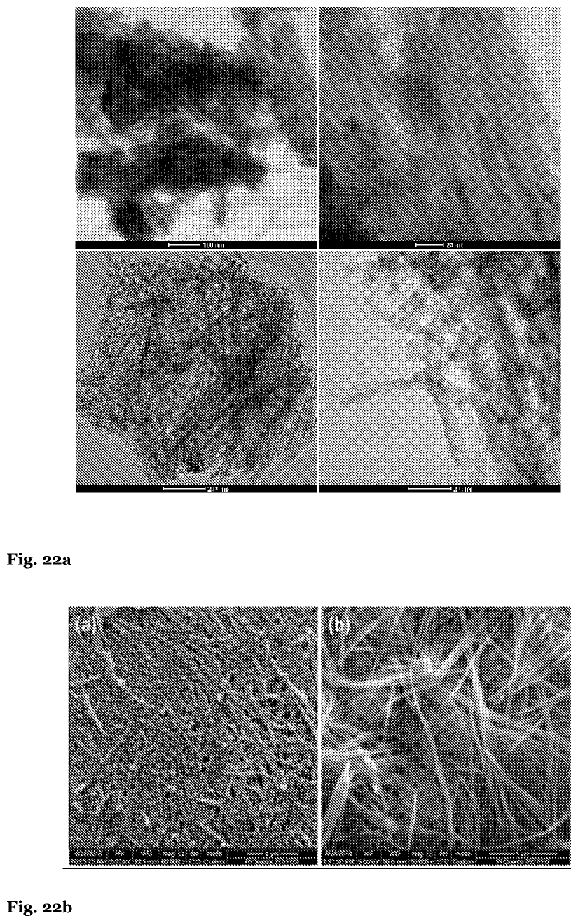

The H₂S adsorption capacity of yolk-shell nanoparticles as in Example 10 (copper hydroxide as copper-based precursor) was measured by breakthrough analysis as described in Example 7 (FIG. 21). As summarized in Table 6, it was shown by variation of the crystallite size of copper oxide nanoparticles (4.3, 6.6, and 13 nm) contained in the hollow sphere of mesoporous silica that a smaller crystallite size of copper oxide nanoparticles leads to a higher sulfur capacity.

TABLE 6
Properties of the yolk-shell nanoparticles with
crystallite sized of copper oxide nanoparticles.

| | | | H₂S adsorption |
|---|---|---|---|
| | | | capacity per amount |
| | | | of CuO at 5 ppm |
| | Crystallite | Relative | breakthrough |
| CuO/SiO₂ yolk- | Size CuO | amount of CuO | concentration |
| shell nanoparticles | (nm) | (% w.t.) | (mmol/g_{CuO}) |
| (a) | 13 | 88.7 | 4.96 |
| (b) | 6.6 | 78.5 | 9.42 |
| (c) | 4.3 | 81.1 | 10.48 |

The data in Table 4 also suggest that size effects on the sulfur capacities of the yolk-shell nanoparticles outperform effects on the sulfur capacities due to variation of the relative amounts by weight of copper-based (CuO) nanoparticles relative to the total weight of the yolk-shell nanoparticles.

### Example 13—Comparison of Reusability of Yolk-shell Nanoparticles According to the Present Invention and State-of-the-art Copper Oxide Nanoparticles

The reusability of yolk-shell nanoparticles according to the present invention, (C), and state-of-the-art copper oxide nanoparticles, (A) and (B), were compared by evaluating the H₂S adsorption capacities (at 150° C. and 100 ppm H₂S in the gas inlet stream and at a breakthrough concentration of 5 ppm H₂S) for several H₂S adsorption—regeneration cycles. (A) were thermally treated CuO nanoparticles (no silica shell), (B) were CuO/SiO₂ nanoparticles obtained without using any surfactant and (C) were CuO/SiO₂ yolk-shell nanoparticles according to the present invention, wherein the copper-based precursor was prepared in water and in the presence of CTAB as a surfactant, and wherein the silica shell was formed around the copper-based precursor in ethanol and water at a pH of 9. The regeneration of the adsorbents (A), (B), and (C) between the H₂S adsorption phases was carried out at 600° C. for 7 hours.

TABLE 7
Summarized comparison of H₂S adsorption capacities of yolk-shell
nanoparticles according to the present invention, (C), and state-
of-the-art copper oxide nanoparticles, (A) and (B). Relative differences
in H₂S adsorption capacities are given in brackets.

| | H₂S adsorption capacities per amount of | | |
|---|---|---|---|
| | CuO at 5 ppm breakthrough concentration | | |
| | (mmol/g_{CuO}) | | |
| | A | B | C |
| | CuO | CuO/SiO₂ | Yolk-shell |
| Cycle | (SG-21B) | (SAD-6B) | (SAD-36/4B) |
| 1^{st} | 9.14 | 7.61 | 4.56 |
| 2^{nd} | 1.26 | 2.75 | 3.67 |
| | (↓86.2%) | (↓63.9%) | (↓19.5%) |
| 3^{rd} | 4.07 | 2.18 | 4.63 |
| | (↓55.5%) | (↓71.3%) | (↑1.5%) |
| 4^{th} | 0.91 | — | 4.9 |
| | | | (↑7.5%) |
| 5^{th} | 0.98 | — | — |

The results according to Table 7 suggest that the reusability of yolk-shell nanoparticles according to the present invention, (C) is three to four times increased in comparison to state-of-the-art copper oxide nanoparticles (A) and (B).

### Example 14—Comprehensive Summary and Comparison of H₂S Adsorption Capacities and Reusability of Yolk-Shell Nanoparticles According to the Present Invention Provided Under Different Reaction Conditions and State-of-the-art Copper Oxide Nanoparticles

### A) Preparation of the Yolk-Shell Nanoparticles According To The Present Invention

Following the synthesis of Cu(OH)₂ in water using the triple amount of the surfactant (1200 mg CTAB instead of 400 mg) in slightly lower pH than 10, four more experiments in water were carried out as given in Table 8a and Table 8b.

All samples were thermally treated after step (iii), i.e. heated to 450° C. for 2 hours (calcination). the effect of various parameters on the final CuO/SiO₂ yolk-shell nanoparticles was studied, including the concentration of surfactant (CTAB, 1× or 3×), the silica source (0.2 m or 0.5 ml TEOS) as well as the absence or the presence of the base of the hydroxide, including the sodium hydroxide (NaOH) and the ammonium hydroxide (NH₄OH).

TABLE 8a
Summarized synthetic parameters of CuO/SiO₂ yolk structures prepared
in the presence of higher amount of CTAB (x3) and in ethanol prepared
in water, ethanol and mixtures of thereof (step (i)).

| | Step (i): | | | | |
|---|---|---|---|---|---|
| | CuSO₄ + ₂NaOH → Cu(OH)₂ (s) + Na₂SO₄ | | | | |
| | Mixture A | | | Mixture B | |
| | Solvent | Surfactant | Precursor | Base | |
| SAMPLE | H₂O | CTAB | CuSO₄ | NaOH | H₂O |
| SG-16A | 100 ml | 0.4 g | 0.5 g | 0.5 g | 50 ml |
| SAD-36/2A | 300 ml | 1.2 g | 1.5 g | 1.5 g | 150 ml |
| SAD-36/1A | (x3) | (x3) | (x3) | (x3) | (x3) |
| SAD-36/3A | | | | | |
| SAD-36/4A | | | | | |

TABLE 8b
Summarized synthetic parameters of CuO/SiO₂ yolk structures prepared
in the presence of higher amount of CTAB (x3) and in ethanol prepared
in water, ethanol and mixtures of thereof (step (ii)).

| Step (ii): | |
|---|---|
| Cu(OH)₂ (s) + TEOS → Cu(OH)₂/SiO₂ | |
| No surfactant! | |
| Mixture C | Mixture D |

| | Solvent | | Base | Precursor |
|---|---|---|---|---|
| SAMPLE | Ethanol | | NH₄OH/H₂O | TEOS |
| SG-16A | 100 | ml | — | 0.5 ml |
| SAD-36/2A | 100 | ml | — | 0.5 ml |
| SAD-36/1A | 100 | ml | — | 0.2 ml |
| SAD-36/3A | 100 | ml | 0.1 g/50 ml | 0.5 ml |
| | | | H₂O | |
| SAD-36/4A | 60 | ml | 2 drops | 0.2 ml |
| | | | H₂O/NH₄OH | |
| | | | (pH = 9) | |

The prepared yolk structure where finally calcined at 450 C. for 2 hours.

### B) Comparison of H₂S Adsorption Capacities and Reusability

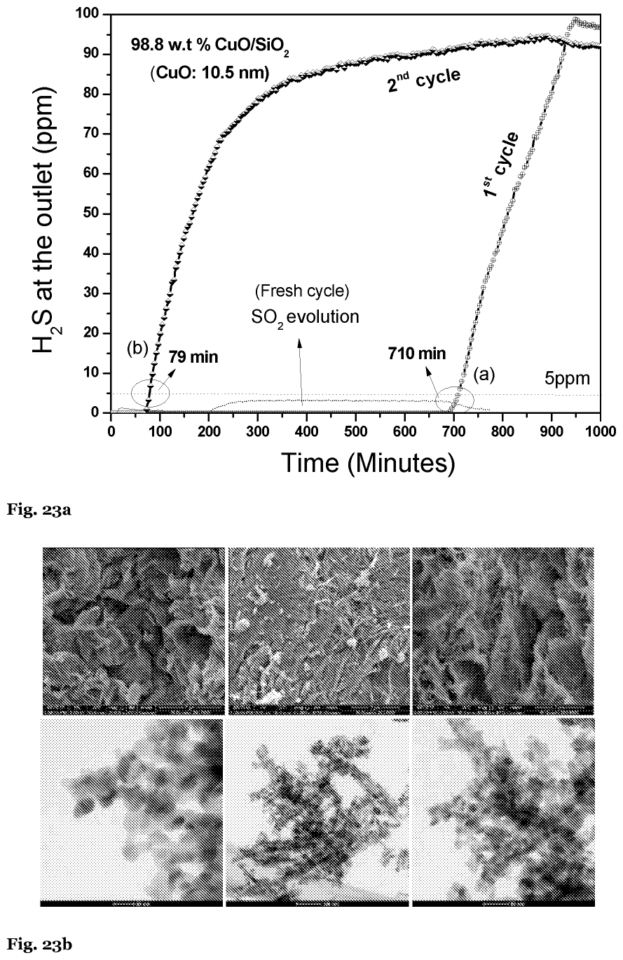

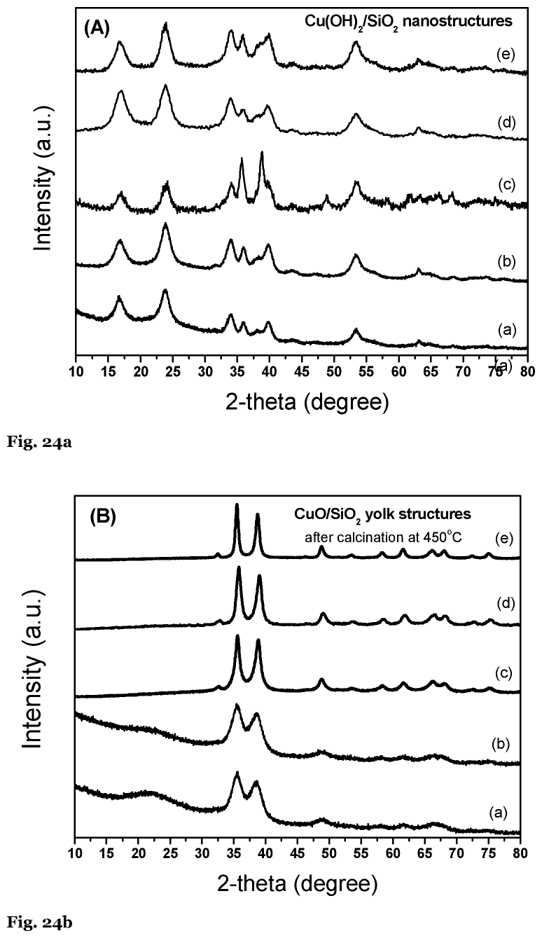

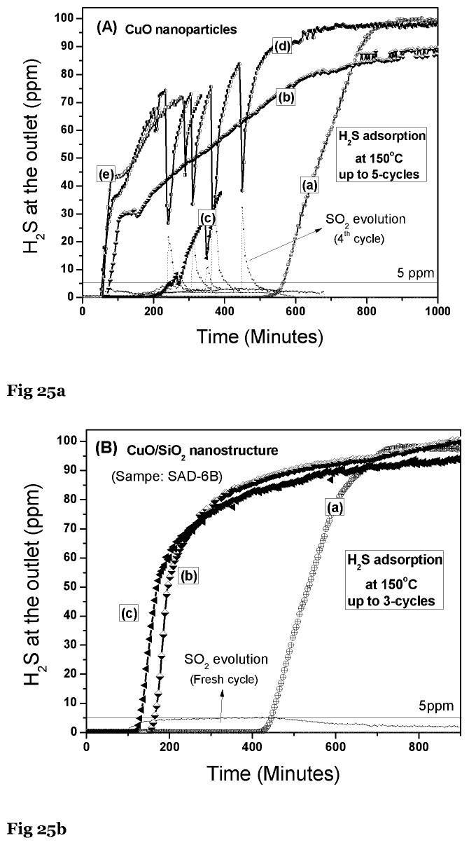

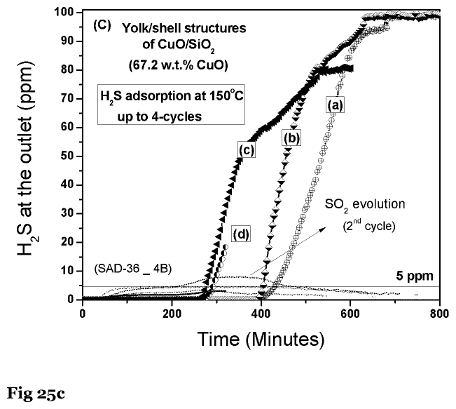

The H₂S adsorption capacities (at 150° C. and wo ppm H₂S in the gas inlet stream and at a breakthrough concentration of 5 ppm H₂S) and the reusability of yolk-shell nanoparticles according to the present invention and state-of-the-art copper oxide nanoparticles, (A) and (B) were compared, wherein the reaction conditions for the preparation of the copper-based precursor (step (i)) and the reaction conditions for the formation of the silica shell (step (ii)) around the copper-based precursor provided in step 1 were considered. The regeneration of the adsorbents between the H₂S adsorption phases was carried out at 600° C. for 7 hours (FIG. 23a and FIG. 25a to FIG. 25c).

TABLE 9
Comprehensive summary and comparison of H₂S adsorption capacities of yolk-
shell nanoparticles according to the present invention provided under different
reaction conditions and state-of-the-art copper oxide nanoparticles.

| | Reaction conditions | | Size | CuO | H₂S adsorption capacities | | |
|---|---|---|---|---|---|---|---|
| Sample | Step (i) | Step (ii) | (nm) | (w.t. %) | 1 | 2 | 3 |
| Ex. 11, | water | water | 5.7 | 81.1 | 10.48 | — | — |
| Tab 5a) | no surfactant | surfactant | | | | | |
| | pH = ? | pH = ? | | | | | |
| Ex. 11, | water | ethanol | 4.4 | 51 | 7.16 | — | — |
| Tab 5c) | no surfactant | surfactant | | | | | |
| | pH = ? | | | | | | |
| SG-16B | water | ethanol | 10.5 | 98.8 | 11.5 | 1.32 (−89%) | — |
| | surfactant | no surfactant | | | | | |
| SAD-36/1B | water | ethanol | 14.5 | 98.4 | 5.41 | 4.09 (−24%) | 3.95 (−3%) |
| | surfactant | no surfactant | | | | | |
| | | less TEOS | | | | | |
| SAD-36/4B | water | ethanol | 8 | 67.2 | 4.56 | 3.67 (−20%) | 4.62 |
| | surfactant | no surfactant | | | | | |
| | | less TEOS | | | | | |
| | | NH₄OH | | | | | |
| | | pH = 9 | | | | | |
| (A) SG-21B | water | | 25.6 | 100 | 9.14 | 1.26 (−86%) | 4.07 (−56%) |
| | surfactant | | | | | | |
| (B) SAD-6B | water | water | <5 | 83.8 | 7.61 | 2.75 (−64%) | 2.18 (−71%) |
| | no surfactant | no surfactant | | | | | |

From the experimental data provided in Table 9 the following conclusions can be drawn:

Yolk-shell nanoparticles with high relative amounts by weight of copper-based (CuO) nanoparticles relative to the total weight of the yolk-shell nanoparticles of >98 w.t. % have high H₂S adsorption capacities. However, yolk-shell nanoparticles with such high relative amounts of CuO are susceptible to sintering during regeneration of the adsorbent. A drop of the initial capacity of more than 80% is observed in the 2^{nd} H₂S adsorption cycle after one regeneration step at 600° C. for 7 h. (FIG. 23a/Table 9 Sample SG-16B). Accordingly, yolk-shell nanoparticles according to the invention with high relative amounts of CuO of 98 w.t. % is the best for non-regenerable adsorbent applications. The comparison to state-of-the-art unsupported (A; SG-21B; FIG. 25a) and supported (B; SAD-6B; FIG. 25b) copper oxide nanoparticles suggests, that yolk-shell nanoparticles according to the invention provide for superior H₂S adsorption capacities in comparison to state-of-the-art H₂S adsorption materials.

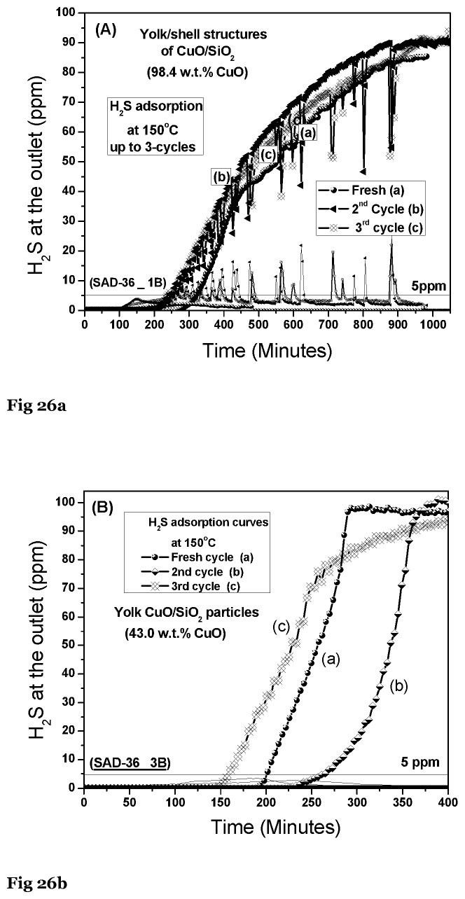

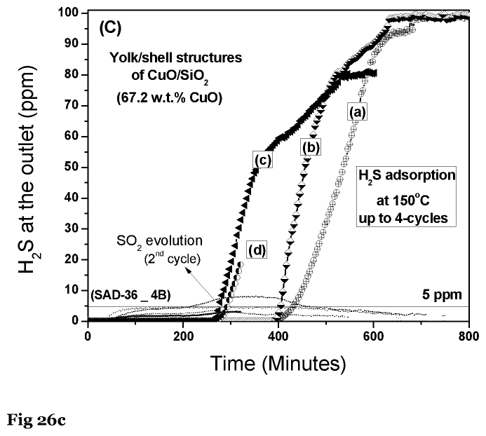

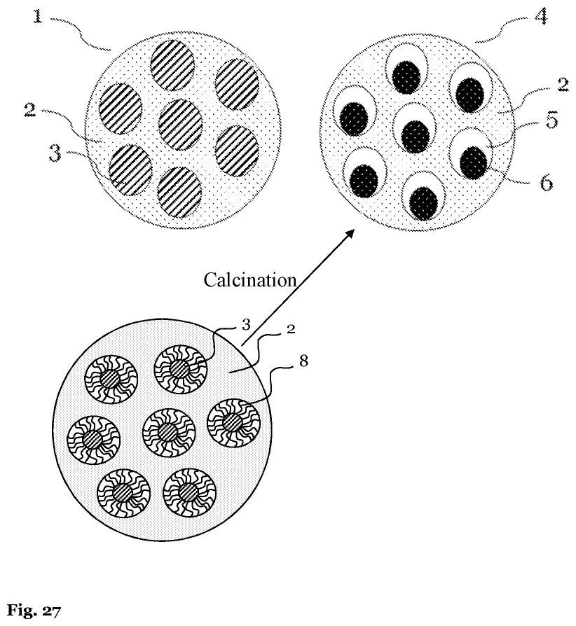

Moreover, yolk-shell nanoparticles according to the invention, wherein the copper-based precursor was prepared in water in the presence of a surfactant in the first step, and in the second step the silica shell was formed around the copper-based precursor in ethanol without the presence of a surfactant (Table 9 Sample SAD-36/4B (FIG. 25c); Table 9 Sample SAD-36/1B (FIG. 26a)), show excellent H₂S adsorption capacities and a high reusability, wherein the initial H₂S adsorption capacity is not reduced more than 25% after one regeneration step at 600° C. for 7h. Accordingly, yolk-shell nanoparticles according to the invention have excellent H₂S adsorption capacities and provide for superior resusabilities in comparison to state-of-the-art H₂S adsorption materials.

### Example 15—Sorption Properties of Yolk-shell Nanoparticles According to the Present

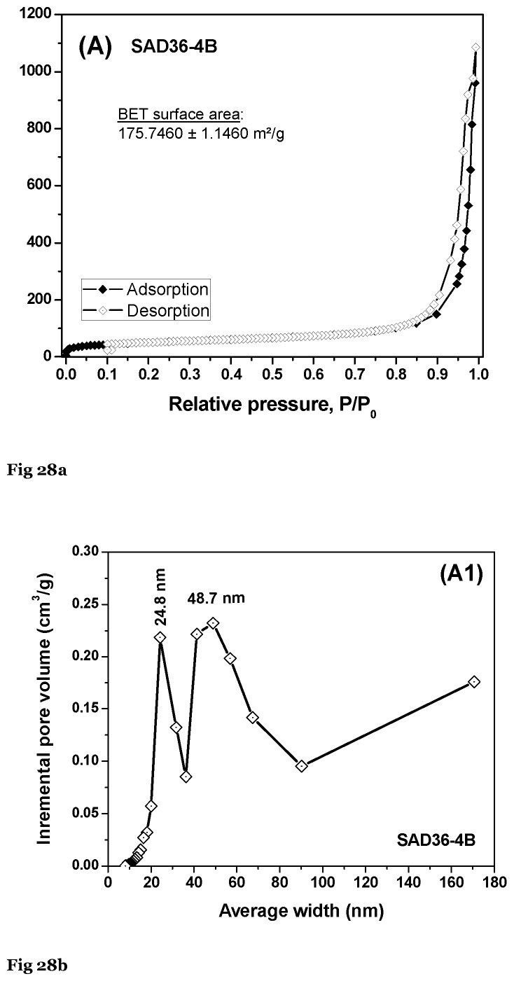

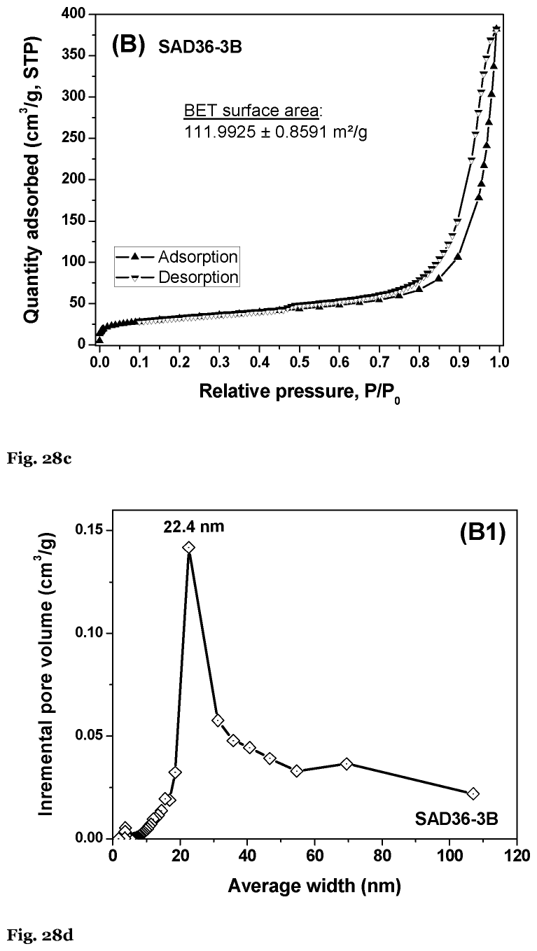

In order to evaluate the sorption properties and pore-size distributions, N₂ adsorption-desorption curves (FIG. 28a and FIG. 28c) were obtained at 77K for the yolk-shell nanoparticles according to the invention (Table 9. Samples SAD-36-4B and SAD-36-3B; also cf. Examples 10 and 14, Table 9, FIG. 14 (c) FIG. 25c and FIG. 26c for Sample SAD-36-4B, as well as Example 10 and FIG. 14 (b) and FIG. 26b for sample SAD-36-3B):

The N₂ adsorption-desorption curves for yolk-shell nanoparticles according to the present invention show hysteresis loops and reveal mesoporous silica shells (FIG. 28a and FIG. 28c). The corresponding pore-size distribution for the two samples are displayed in the following Table 10 and FIG. 28b and FIG. 28d.

TABLE 10
Summarized sorption properties of 8 nm CuO/SiO₂ yolk
shell nanoparticles according to the present invention
with different CuO loadings of 67.2 w.t. CuO (SAD-
36-4B) and 43.0 w.t % CuO (SAD-36-3B).

| Sample | SAD36-4B | SAD36-3B |
|---|---|---|
| Size of CuO | 8 nm | 8 nm |
| crystallites (nm) | | |
| CuO (w.t. %) | 67.2% CuO | 43% CuO |
| SiO₂ (% w.t.) | 32.8% SiO₂ | 57% SiO₂ |
| BET Surface area | 175.3 | 112.0 |
| (m²/g) | | |
| Average pore-size | 24.8 and 48.7 | 22.4 |
| (nm) | | |

As can be seen from the data presented in Table 10, the sample having a relative amount per weight of CuO of 67.2 w.t. % (SAD-36-4B) shows a bimodal pore-size distribution with mean pore diameters of 24.8 nm and 48.7 nm. The sample having a relative amount per weight of CuO of 43 w.t. % (SAD-36-4B) shows a unimodal pore-size distribution with mean pore diameters of 22.4 nm. The pore-size distribution of both samples reveal that the pores of the silica shell are in the mesoporous range. Without wishing to be bound by theory, the yolk-shell nanoparticle's silica shell having pores in the mesoporous range allows diffusion of molecules from the exterior through the silica shell to the CuO crystallites in the inside of the yolk-shell nanoparticles, while movement of CuO crystallites between individual yolk-shell nanoparticles and subsequent sintering is prevented.

1. Yolk-shell nanoparticles comprising a mesoporous silica shell and one or more copper-based nanoparticles, wherein the one or more copper-based nanoparticles are contained by the mesoporous silica shell and wherein there is a void space between the mesoporous silica shell and the one or more copper-based nanoparticles.

2. Yolk-shell nanoparticles according to claim 1, wherein the one or more copper-based nanoparticles are selected from the group consisting of copper oxide, copper sulfide, copper sulfate, and/or copper hydroxide nanoparticles, or any combination thereof.

3. Yolk-shell nanoparticles according to claim 1, the one or more copper-based nanoparticles comprise copper sulfide nanoparticles, or copper sulfate nanoparticles, or copper hydroxide nanoparticles, or copper oxide nanoparticles.

4. Yolk-shell nanoparticles according to claim 1, wherein the one or more copper-based nanoparticles are copper oxide nanoparticles.

5. Yolk-shell nanoparticles according to claim 1, wherein the one or more copper-based nanoparticles have monodisperse particle sizes.

6. Yolk-shell nanoparticles according to claim 5, wherein the one or more copper-based nanoparticles have a monodisperse particle size from 1 to 50 nm.

7. Yolk-shell nanoparticles according to claim 1, wherein the one or more copper-based nanoparticles have a monodisperse particle size from 1 to 15 nm.

8. Yolk-shell nanoparticles according to claim 1, wherein the one or more copper-based nanoparticles have a monodisperse particle size from 1 to 7 nm.

9. Yolk-shell nanoparticles according to claim 1, wherein the average pore size of the pores within the mesoporous silica shell is in the range from 10 to 40 nm.

10. Yolk-shell nanoparticles according to claim 1, wherein the yolk-shell nanoparticles comprise a relative amount by weight of copper-based nanoparticles relative to the total weight of the yolk-shell nanoparticles of 25 to 99 w.t. %.

11. Yolk-shell nanoparticles according to any of claim 1, wherein the yolk-shell nanoparticles comprise one or more copper oxide nanoparticles having a monodisperse particle size from 1 to 25 nm.

12. A process for H₂S removal from a gas stream comprising the steps of:
(i) Adsorbing H₂S from a gas stream comprising H₂S using the yolk-shell nanoparticles according to claim 1, wherein the yolk-shell nanoparticles are exposed to the H₂S-comprising gas stream until the H₂S-adsorption capacity of the yolk-shell nanoparticles is reached; and, optionally, (ii) regenerating the yolk-shell nanoparticles, wherein the yolk-shell nanoparticles are heated in an oxidant stream until the respective copper-based nanoparticles residing in the hollow spheres of the yolk-shell nanoparticles are regenerated, which efficiently adsorb H₂S from gas streams again.

13. The process according to claim 12, wherein the yolk-shell nanoparticles are regenerated in step (ii) after adsorbing H₂S from a gas stream comprising H₂S in step (i).

14. The process according to claim 13, wherein the yolk-shell nanoparticles are regenerated in step (ii) and wherein in step (ii) the yolk-shell nanoparticles are heated in an oxidant stream to a temperature of at least 500° C.

15. The process according to claim 12, wherein the yolk-shell nanoparticles are regenerated in step (ii) and wherein in step (ii) the yolk-shell nanoparticles are heated in an oxidant stream for 1 hour.

16. The process according to claim 12, wherein the yolk-shell nanoparticles are regenerated in step (ii) and wherein in step (ii) the yolk-shell nanoparticles are heated in an oxidant stream to a temperature of 600° C. for 7 hours.

17. The process according to claim 12, wherein the yolk-shell nanoparticles are regenerated in step (ii) and wherein in step (ii) the oxidant stream comprises an oxidant gas or gas mixture.

18. The process according to claim 12, wherein the yolk-shell nanoparticles comprise one or more copper oxide nanoparticles having a monodisperse particle size from1 to 50 nm.

19-26. (canceled)

27. Use of yolk-shell nanoparticles in a process for H₂S removal from a gas stream comprising the steps of:
(i) Adsorbing H₂S from a gas stream comprising H₂S using the yolk-shell nanoparticles according to claim 1, wherein the yolk-shell nanoparticles are exposed to the H₂S -comprising gas stream until the H₂S-adsorption capacity of the yolk-shell nanoparticles is reached; and, optionally,
(ii) regenerating the yolk-shell nanoparticles, wherein the yolk-shell nanoparticles are heated in an oxidant stream until the one or more respective copper-based nanoparticles residing in the hollow spheres of the yolk-shell nanoparticles are regenerated, which efficiently adsorb H₂S from gas streams again.

28-41. (canceled)

42. A process for producing the yolk-shell nanoparticles according to claim 1 comprising the steps of:
(i) providing a copper-based precursor having a low density;
(ii) forming a silica shell around the provided copper-based precursor;
(iii) thermally treating the silica shell comprising the provided copper-based precursor.

43-66. (canceled)
